(19) United States
(12) Patent Application Publication
(10) Pub. No.: US 2024/0089025 A1
(43) Pub. Date: Mar. 14, 2024

(54) NETWORK CODING GROUP FOR NETWORK CODED SIDELINK TRANSMISSIONS

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Gabi SARKIS, San Diego, CA (US)

(21) Appl. No.: 17/943,045

(22) Filed: Sep. 12, 2022

(51) Int. Cl. H04L 1/00

(52) U.S. Cl. CPC H04L 1/0009

(57) ABSTRACT

Aspects relate to mechanisms for forming a network coding group for coordinated sidelink network coding. Two or more wireless communication devices may exchange sidelink messages with one another to form the network coding group. For example, the sidelink messages may indicate a respective capability of each of the wireless communication devices to support sidelink network coding. A first wireless communication device within the network coding group may then transmit a network coded sidelink transmission including transport blocks associated with at least a first sidelink transmission and a second sidelink transmission to at least a second wireless communication device in the network coding group. The second wireless communication device is an intended recipient of at least one of the first or second sidelink transmission.

### INTRODUCTION

The technology discussed below relates generally to wireless communication networks, and more particularly, to wireless communication in sidelink networks.

Wireless communication between devices may be facilitated by various network configurations. In one configuration, a cellular network may enable user equipment (UEs) to communicate with one another through signaling with a nearby base station or cell. Another wireless communication network configuration is a device to device (D2D) network in which UEs may signal one another directly, rather than via an intermediary base station or cell. For example, D2D communication networks may utilize sidelink signaling to facilitate the direct communication between UEs over a proximity service (ProSe) PC5 interface. In some sidelink network configurations, UEs may further communicate in a cellular network, generally under the control of a base station. Thus, the UEs may be configured for uplink and downlink signaling via a base station and further for sidelink signaling directly between the UEs without transmissions passing through the base station.

Sidelink communication may be transmitted in units of slots in the time domain and in units of sub-channels in the frequency domain Each slot may include both sidelink control information (SCI) and sidelink data traffic. The SCI may be transmitted over a physical sidelink control channel (PSCCH), while the sidelink data traffic may be transmitted over a physical sidelink shared channel (PSSCH) within resources reserved on a sidelink carrier by the SCI. A receiving UE may transmit feedback information, such as hybrid automatic repeat request (HARQ) feedback information including an acknowledgement (ACK) or negative acknowledgement (NACK) of the sidelink data traffic, on a physical sidelink feedback channel (PSFCH).

### BRIEF SUMMARY

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a first wireless communication device configured for wireless communication is disclosed. The first wireless communication device includes a memory, and a processor coupled to the memory. The processor is configured to exchange one or more sidelink messages with a second wireless communication device to form a network coding group including at least the first wireless communication device and the second wireless communication device based on a respective capability of each of the first wireless communication device and the second wireless communication device to support sidelink network coding. The processor is further configured to transmit a network coded sidelink transmission including at least a first sidelink transmission and a second sidelink transmission to at least the second wireless communication device, in which the second wireless communication device is an intended recipient of at least one of the first sidelink transmission or the second sidelink transmission.

Another example provides a method for wireless communication at a first wireless communication device. The method includes exchanging one or more sidelink messages with a second wireless communication device to form a network coding group including at least the first wireless communication device and the second wireless communication device based on a respective capability of each of the first wireless communication device and the second wireless communication device to support sidelink network coding. The method further includes transmitting a network coded sidelink transmission including at least a first sidelink transmission and a second sidelink transmission to at least the second wireless communication device, in which the second wireless communication device is an intended recipient of at least one of the first sidelink transmission or the second sidelink transmission.

Another example provides a first wireless communication device configured for wireless communication. The first wireless communication device includes means for exchanging one or more sidelink messages with a second wireless communication device to form a network coding group including at least the first wireless communication device and the second wireless communication device based on a respective capability of each of the first wireless communication device and the second wireless communication device to support sidelink network coding. The first wireless communication device further includes means for transmitting a network coded sidelink transmission including at least a first sidelink transmission and a second sidelink transmission to at least the second wireless communication device, in which the second wireless communication device is an intended recipient of at least one of the first sidelink transmission or the second sidelink transmission.

Another example provides a non-transitory computer-readable medium having stored therein instructions executable by one or more processors of a first wireless communication device to exchange one or more sidelink messages with a second wireless communication device to form a network coding group including at least the first wireless communication device and the second wireless communication device based on a respective capability of each of the first wireless communication device and the second wireless communication device to support sidelink network coding. The non-transitory computer-readable medium further includes instructions executable by the one or more processors of the first wireless communication device to transmit a network coded sidelink transmission including at least a first sidelink transmission and a second sidelink transmission to at least the second wireless communication device, in which the second wireless communication device is an intended recipient of at least one of the first sidelink transmission or the second sidelink transmission.

Another example provides a second wireless communication device configured for wireless communication. The second wireless communication device includes a memory and a processor coupled to the memory. The processor is configured to exchange one or more sidelink messages with a first wireless communication device to form a network coding group including at least the first wireless communication device and the second wireless communication device based on a respective capability of each of the first wireless communication device and the second wireless communication device to support sidelink network coding. The processor is further configured to receive a network coded sidelink transmission including at least a first sidelink transmission and a second sidelink transmission from the first wireless communication device, in which the second wireless communication device is an intended recipient of at least one of the first sidelink transmission or the second sidelink transmission.

Another example provides a method for wireless communication at a second wireless communication device. The method includes exchanging one or more sidelink messages with a first wireless communication device to form a network coding group including at least the first wireless communication device and the second wireless communication device based on a respective capability of each of the first wireless communication device and the second wireless communication device to support sidelink network coding. The method further includes receiving a network coded sidelink transmission including at least a first sidelink transmission and a second sidelink transmission from the first wireless communication device, the second wireless communication device being an intended recipient of at least one of the first sidelink transmission or the second sidelink transmission.

Another example provides a second wireless communication device configured for wireless communication. The second wireless communication device includes means for exchanging one or more sidelink messages with a first wireless communication device to form a network coding group including at least the first wireless communication device and the second wireless communication device based on a respective capability of each of the first wireless communication device and the second wireless communication device to support sidelink network coding. The second wireless communication device further includes means for receiving a network coded sidelink transmission including at least a first sidelink transmission and a second sidelink transmission from the first wireless communication device, the second wireless communication device being an intended recipient of at least one of the first sidelink transmission or the second sidelink transmission.

Another example provides a non-transitory computer-readable medium having stored therein instructions executable by one or more processors of a second wireless communication device to exchange one or more sidelink messages with a first wireless communication device to form a network coding group including at least the first wireless communication device and the second wireless communication device based on a respective capability of each of the first wireless communication device and the second wireless communication device to support sidelink network coding. The non-transitory computer-readable medium further includes instructions executable by the one or more processors of the second wireless communication device to receive a network coded sidelink transmission including at least a first sidelink transmission and a second sidelink transmission from the first wireless communication device, in which the second wireless communication device is an intended recipient of at least one of the first sidelink transmission or the second sidelink transmission.

Another example provides a network entity including a memory, and a processor coupled to the memory. The processor can be configured to provide a resource allocation of a plurality of resources dedicated for network coded sidelink transmissions to a plurality of wireless communication devices in a network coding group configured for coordinated sidelink network coding. The plurality of resources including one or more resource pools of a plurality of resource pools. The processor is further configured to provide at least one respective pattern for network coded sidelink transmissions for each of the one or more resource pools, in which each of the at least one respective pattern for each of the one or more resource pools includes a sequence of sidelink transmissions including one or more network coded sidelink transmissions.

Another example provides a method for wireless communication at a network entity. The method includes providing a resource allocation of a plurality of resources dedicated for network coded sidelink transmissions to a plurality of wireless communication devices in a network coding group configured for coordinated sidelink network coding. The plurality of resources including one or more resource pools of a plurality of resource pools. The method further includes providing at least one respective pattern for network coded sidelink transmissions for each of the one or more resource pools, in which each of the at least one respective pattern for each of the one or more resource pools includes a sequence of sidelink transmissions including one or more network coded sidelink transmissions.

Another example provides a network entity including means for providing a resource allocation of a plurality of resources dedicated for network coded sidelink transmissions to a plurality of wireless communication devices in a network coding group configured for coordinated sidelink network coding. The plurality of resources including one or more resource pools of a plurality of resource pools. The network entity further includes means for providing at least one respective pattern for network coded sidelink transmissions for each of the one or more resource pools, in which each of the at least one respective pattern for each of the one or more resource pools includes a sequence of sidelink transmissions including one or more network coded sidelink transmissions.

Another example provides a non-transitory computer-readable medium having stored therein instructions executable by one or more processors of a network entity to provide a resource allocation of a plurality of resources dedicated for network coded sidelink transmissions to a plurality of wireless communication devices in a network coding group configured for coordinated sidelink network coding. The plurality of resources including one or more resource pools of a plurality of resource pools. The non-transitory computer-readable medium further includes instructions executable by the one or more processors of the network entity to provide at least one respective pattern for network coded sidelink transmissions for each of the one or more resource pools, in which each of the at least one respective pattern for each of the one or more resource pools includes a sequence of sidelink transmissions including one or more network coded sidelink transmissions.

These and other aspects will become more fully understood upon a review of the detailed description, which follows. Other aspects, features, and examples will become apparent to those of ordinary skill in the art, upon reviewing the following description of specific, exemplary aspects of in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects, such exemplary aspects can be implemented in various devices, systems, and methods.

### BRIEF DESCRIPTION OF THE DRAWINGS

FIG. 1 is a diagram illustrating an example of a wireless radio access network according to some aspects.

FIG. 2 is a diagram illustrating an example of a wireless communication network employing sidelink communication according to some aspects.

FIG. 3 is a diagram illustrating an example of a frame structure for use in a wireless communication network according to some aspects.

FIGS. 4A and 4B are diagrams illustrating examples of sidelink slot structures according to some aspects.

FIG. 5 is a diagram illustrating an example of a sidelink slot structure with feedback resources according to some aspects.

FIGS. 6A and 6B are diagrams illustrating examples of sidelink resource reservation according to some aspects.

FIG. 7 is a diagram illustrating an example of the formation of a network coding group according to some aspects.

FIG. 8 is a diagram illustrating an example of initial sidelink transmissions within a network coding group according to some aspects.

FIG. 9 is a diagram illustrating an example of a network coded sidelink transmission within a network coding group according to some aspects.

FIG. 10 is a signaling diagram illustrating exemplary signaling between wireless communication devices for sidelink network coding according to some aspects.

FIGS. 11A-11D are diagrams illustrating examples of network coded sidelink transmissions between wireless communication devices within network coding groups according to some aspects.

FIG. 12 is a signaling diagram illustrating other exemplary signaling between wireless communication devices for sidelink network coding according to some aspects.

FIG. 13 is a diagram illustrating an example of resources selected for a network coded sidelink transmission according to some aspects.

FIG. 14 is a signaling diagram illustrating other exemplary signaling between a network entity and wireless communication devices for sidelink network coding according to some aspects.

FIG. 15 is a diagram illustrating an example of a slot used for network coding according to some aspects.

FIG. 16 is a diagram illustrating an example of another slot used for network coding according to some aspects.

FIG. 17 is a flowchart illustrating a process for selective network coding according to some aspects.

FIG. 18 is a block diagram illustrating an example of a hardware implementation for a wireless communication device employing a processing system according to some aspects.

FIG. 19 is a flow chart of an exemplary process for network coded sidelink transmissions within a network coding group according to some aspects.

FIG. 20 is a flow chart of another exemplary process for network coded sidelink transmissions within a network coding group according to some aspects.

FIG. 21 is a block diagram illustrating an example of a hardware implementation for a network entity employing a processing system according to some aspects.

FIG. 22 is a flow chart of an exemplary process for facilitating network coded sidelink transmissions within a network coding group according to some aspects.

FIG. 23 is a diagram providing a high-level illustration of one example of a configuration of a disaggregated base station according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and features are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, aspects and/or uses may come about via integrated chip devices and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described aspects may occur. Implementations may range in spectrum from chip-level or modular components to non-modular, non-chip-level implementations and further to aggregate, distributed, or OEM devices or systems incorporating one or more aspects of the described aspects. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, disaggregated arrangements (e.g., base station and/or UE), end-user devices, etc. of varying sizes, shapes and constitution.

Sidelink retransmission of one or more transport blocks may be accomplished by network coding. Network coding uses an encoding function of two or more previously transmitted transport blocks to produce a network coded transmission of the two or more transport blocks. The network coded transmission, along with initial transmissions of the transport blocks, facilitates decoding of the transport blocks at the receiver(s). For example, a transmitting wireless communication device (e.g., a sidelink device or other suitable UE) may transmit an initial sidelink transmission of a transport block (or packet) to one or more receiving wireless communication devices (e.g., UEs) and a network coding device over a sidelink data channel (e.g., a PSSCH). The network coding device may be, for example, a roadside unit (RSU), another UE (including one of the receiving UEs), or a network entity (e.g., an aggregated or disaggregated base station). The initial sidelink transmission may include a network coding request flag that requests the network coding device to initiate one or more sidelink retransmissions of the transport block. The network coding device may then transmit a network coding accept request message to the transmitting wireless communication device to indicate whether the network coding device will perform network coding of the packet. If the network coding device accepts network coding of the transport block, the network coding device may then retransmit the transport block, together with one or more other transport blocks, to the one or more receiving UEs as a network coded sidelink transmission.

In some examples, the network coding device may utilize an encoding function of each of the initial sidelink transmissions to produce the network coded sidelink transmission. One example of an encoding function is erasure coding (e.g., XOR). With erasure coding, a receiving UE may recover an erased (incorrectly decoded) transmission by summing the other correctly decoded transmissions. For example, if the network coded sidelink transmission corresponds to Txₐ⊕Tx_{b} and the receiving UE previously correctly decoded Txₐ, the receiving UE can recover the erased Tx_{b} by summing Txₐ with the network coded sidelink transmission Txₐ⊕Tx_{b} as follows: Txₐ ⊕(Txₐ⊕Tx_{b}). The network coding device may further utilize any type of channel coding (separate from the network coding) for subsequently encoding the network coded sidelink transmission. By way of example, but not limitation, the network coding device may utilize turbo coding, low density parity check (LDPC) coding, polar coding, etc. to encode the network coded sidelink transmission.

Since network coding is facilitated through the use of a dedicated network coding device, network coding may be unavailable in some areas or in some network configurations. In addition, network coding is initiated using a network coding request flag and a network coding accept request message, which may increase the signaling overhead in the network.

Various aspects are directed to techniques for forming a network coding group for coordinated sidelink network coding among the members of the network coding group. Two or more wireless communication devices within range of one another (e.g., having a sidelink connection therebetween) may exchange sidelink messages with one another to form the network coding group. For example, the sidelink messages may indicate a respective capability of each of the wireless communication devices to support sidelink network coding. In some examples, the capability of a wireless communication device may be based, at least in part, on energy (e.g., power) available for network coding at the wireless communication device. For example, network encoding and decoding may be power prohibitive since joint encoding/decoding is performed and successive decoding cancellation may be performed at the decoder. The energy (e.g., power) available for network coding may vary over time. Therefore, the capability may be a dynamic capability based on an energy status of the wireless communication device.

A transmitting wireless communication device within the network coding group may transmit a network coded sidelink transmission including transport blocks associated with at least two initial sidelink transmissions to one or more receiving wireless communication devices within the network coding group. In some examples, the initial sidelink transmissions may have been initiated by the transmitting wireless communication device. In other examples, at least one of the initial sidelink transmissions may have been initiated by another wireless communication device within the network coding group. In some examples, the transmitting wireless communication devices may listen to a sidelink channel to receive the initial sidelink transmission(s) from other wireless communication device(s) in the network coding group.

In some examples, the transmitting wireless communication device may further decide whether to transmit the network coded sidelink transmission based on respective feedback received for each of the initial sidelink transmissions. For example, the transmitting wireless communication device may transmit the network coded sidelink transmission upon receiving (or listening to) a negative acknowledgement (NACK) for at least one of the initial sidelink transmissions. In other examples, the transmitting wireless communication device may transmit the network coded sidelink transmission regardless of the feedback received for each of the initial sidelink transmissions. In other examples, the transmitting wireless communication device may decide whether to transmit the network coded sidelink transmission or a retransmission of an initial sidelink transmission initiated by the transmitting wireless communication device based on one or more of a quality of the sidelink channel, a priority of the initial sidelink transmission, a quality of service (QoS) of the initial sidelink transmission, a remaining packet delay budget of the initial sidelink transmission, or a fixed number of retransmissions associated with the initial sidelink transmission. In some examples, a subsequent sidelink transmission (e.g., a network coded sidelink transmission or a sidelink retransmission) may include sidelink control information (SCI) including a sidelink transmission type field indicating a type of transmission (e.g., whether the subsequent sidelink transmission is a network coded sidelink transmission type or a sidelink retransmission type).

In other examples, the transmitting wireless communication device may decide whether to transmit the network coded sidelink transmission based on a probability of transmitting the network coded sidelink transmission instead of respective individual retransmissions of the initial sidelink transmissions. For example, the probability may be based on one or more of a quality of the sidelink channel, a respective priority of at least one of the initial sidelink transmissions, a respective quality of service (QoS) of at least one of the initial sidelink transmissions, or a respective remaining packet delay budget of each of the initial sidelink transmissions. In some examples, the probability may be optimized based on the probabilities shared from other wireless communication devices directly or through the network (e.g., via a network entity).

In some examples, the transmitting wireless communication device and at least one other wireless communication device within the network coding group may each select a respective resource for the network coded sidelink transmission. In one example, the resource selected by the transmitting wireless communication device may be an earlier resource of the resources selected by the various members (e.g., wireless communication devices) of the network coding group, and therefore, the other wireless communication devices in the network coding group may explicitly or implicitly release their selected resources. In another example, each wireless communication device within the network coding group that selected a resource for the network coded sidelink transmission may use their respective selected resource to transmit the network coded sidelink transmission. In some examples, the wireless communication devices within the network coding group may select between using the earlier resource or all of the selected resources for the network coded sidelink transmission based on pre-configuration or a priority of the transport block(s).

In some examples, the wireless communication devices within the network coding group may receive a resource allocation of a plurality of resources dedicated for network coded sidelink transmissions from a network entity. The resources may be grant-based or grant-free (e.g., shared) resources. For example, the plurality of resources may include one or more resource pools. In some examples, the network entity may further provide an indication enabling (activating) a network coding feature for each of the one or more resource pools. In some examples, the network entity may enable (activate) the network coding feature for one or more of the resource pools, may enable (activate) the network coding feature for one or more resource pools for a duration, or may enable (activate) the network coding feature for one or more of the resource pools until a disable (deactivation) indication is provided. In other examples, a set of wireless communication devices (e.g., within the network coding group) may activate or deactivate the network coding feature for a resource pool.

In some examples, the network entity may further configure one or more patterns for network coded sidelink transmissions. The patterns may be configured per resource pool or for all resource pools. In some examples, the transmitting wireless communication device may select a pattern from available patterns configured for the resource pool including a resource over which the network coded sidelink transmission is communicated. For example, the network entity may schedule the resource for the network coded sidelink transmission, and the transmitting wireless communication device may select the pattern from the configured patterns for the resource pool containing the scheduled resource. Each pattern indicates a sequence of sidelink transmissions, which may include the initial sidelink transmissions and one or more network coded sidelink transmissions, each using a respective network encoding function (e.g., Erasure encoding, or other suitable encoding).

In some examples, the transmitting wireless communication device and other members of the network coding group may select the resource pool and pattern for network coded sidelink transmissions. For example, the resource pool and/or pattern may be selected upon forming the network coding group. In some examples, the pattern may be selected dynamically for a sequence of sidelink transmissions between the transmitting wireless communication device and other wireless communication devices in the network coding group.

By forming a network coding group to facilitate network coding, network coding may be available in areas without a network coding device. Moreover, the signaling overhead, and as such, the power consumed by the wireless communication devices in the network coding group, may be reduced.

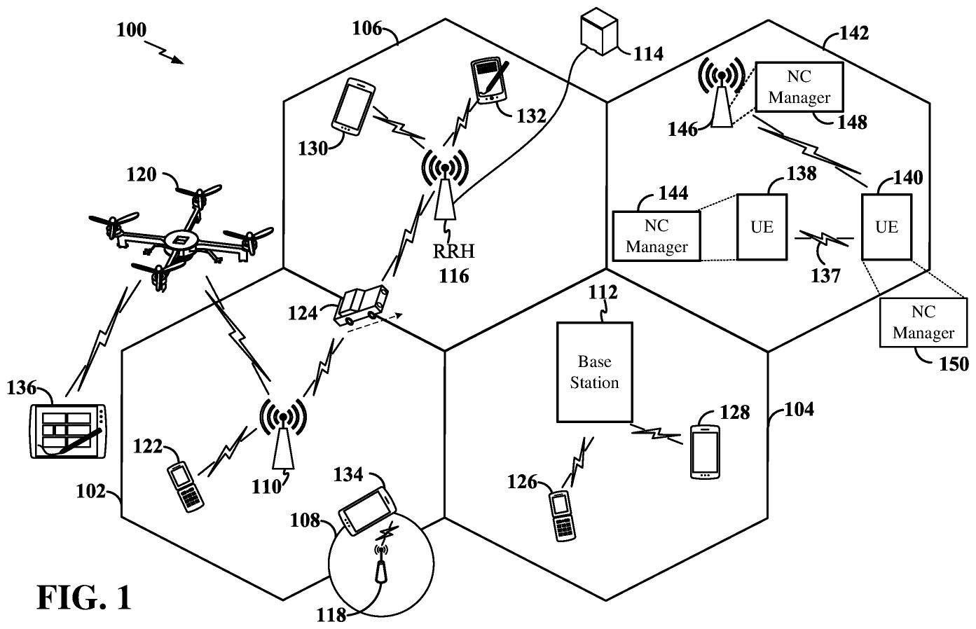

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates cells 102, 104, 106, cell 108, and cell 142, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network entity in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a base station may include two or more TRPs that may be collocated or non-collocated. Each TRP may communicate on the same or different carrier frequency within the same or different frequency band. In examples where the RAN 100 operates according to both the LTE and 5G NR standards, one of the base stations may be an LTE base station, while another base station may be a 5G NR base station. A base station may further be implemented in an aggregated or a disaggregated architecture.

Various base station arrangements can be utilized. For example, in FIG. 1, base stations 110, 112, and 146 are shown in cells 102, 104, and 142; and another base station 114 is shown controlling a remote radio head (RRH) 116 in cell 106. That is, a base station can have an integrated antenna or can be connected to an antenna or RRH by feeder cables. In the illustrated example, the cells 102, 104, 106, and 142 may be referred to as macrocells, as the base stations 110, 112, 114, and 146 support cells having a large size. Further, a base station 118 is shown in the cell 108 which may overlap with one or more macrocells. In this example, the cell 108 may be referred to as a small cell (e.g., a microcell, picocell, femtocell, home base station, home Node B, home eNode B, etc.), as the base station 118 supports a cell having a relatively small size. Cell sizing can be done according to system design as well as component constraints.

It is to be understood that the radio access network 100 may include any number of wireless base stations and cells. Further, a relay node may be deployed to extend the size or coverage area of a given cell. The base stations 110, 112, 114, 118, and 146 provide wireless access points to a core network for any number of mobile apparatuses.

FIG. 1 further includes an unmanned aerial vehicle (UAV) 120, which may be a drone or quadcopter. The UAV 120 may be configured to function as a base station, or more specifically as a mobile base station. That is, in some examples, a cell may not necessarily be stationary, and the geographic area of the cell may move according to the location of a mobile base station such as the UAV 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 via RRH 116; UEs 138 and 140 may be in communication with base station 146; and UE 136 may be in communication with mobile base station 120. Here, each base station 110, 112, 114, 118, 120, and 146 may be configured to provide an access point to a core network (not shown) for all the UEs in the respective cells. In another example, a mobile network node (e.g., UAV 120) may be configured to function as a UE. For example, the UAV 120 may operate within cell 102 by communicating with base station 110.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (described further below; e.g., UE 122).

For example, DL transmissions may include unicast or broadcast transmissions of control information and/or data (e.g., user data traffic or other type of traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, access to the air interface may be scheduled, wherein a scheduling entity (e.g., a base station 112) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 126), which may be scheduled entities, may utilize resources allocated by the scheduling entity 112.

Base stations are not the only entities that may function as scheduling entities. That is, in some examples, a UE may function as a scheduling entity, scheduling resources for one or more scheduled entities (e.g., one or more other UEs). For example, two or more UEs (e.g., UEs 138 and 140) may communicate with each other using peer to peer (P2P) or sidelink signals 137 without relaying that communication through a base station (e.g., base station 146). In some examples, the UEs 138 and 140 may each function as a scheduling entity or transmitting sidelink device and/or a scheduled entity or a receiving sidelink device to communicate sidelink signals 137 therebetween without relying on scheduling or control information from a base station (e.g., base station 146). In other examples, the base station 146 may allocate resources to the UEs 138 and 140 for sidelink communication. For example, the UEs 138 and 140 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the base station 112 via D2D links (e.g., sidelink 137). For example, one or more UEs (e.g., UE 138) within the coverage area of the base station 146 may operate as a relaying UE to extend the coverage of the base station 146, improve the transmission reliability to one or more UEs (e.g., UE 140), and/or to allow the base station to recover from a failed UE link due to, for example, blockage or fading.

In some examples, one or more of the UEs (e.g., UE 138 and UE 140) may support network coding. In this example, each of the UEs 138 and 140 may include a network coding (NC) manager 144 and 150, respectively, configured to form a network coding group including the UEs 138 and 140. For example, the NC managers 144 and 150 may be configured to exchange sidelink messages between the UEs 138 and 140 over a sidelink channel (e.g., sidelink 137) to form a network coding group based on the capability of each of the UEs 138 and 140 to support network coding. Upon establishing the network coding group, one of the UEs (e.g., UE 138) may transmit a network coded sidelink transmission including transport blocks associated with at least two initial sidelink transmissions to the other UE (e.g., UE 140). For example, UE 138 may transmit a first sidelink transmission including a first transport block to the UE 140, and may further transmit a second sidelink transmission including a second transport block to the UE 140. The UE 138 (e.g., NC manager 144) may then transmit a network coded sidelink transmission including the first and second transport blocks to the UE 140.

The UE 138 may transmit the network coded sidelink transmission on a resource (e.g., time-frequency resource). In some examples, the NC manager 144 within the UE 138 may select the resource for the network coded sidelink transmission. For example, the NC manager 144 may select the resource from a resource pool configured for sidelink communication generally or from a resource pool dedicated for network coded sidelink communication. In some examples, the NC manager 144 may further select a pattern (e.g., a sequence of sidelink transmissions) associated with the network coded sidelink transmission. The UE 138 may then transmit the network coded sidelink transmission as part of the pattern for network coded sidelink transmissions.

The resource pool used for the network coded sidelink transmission may be pre-configured (e.g., via one or more standards or specifications) or may be configured by the base station 146. For example, the base station 146 may further include an NC manager 148 configured to provide a resource allocation of a plurality of resources (e.g., one or more resource pools) dedicated for network coded sidelink transmissions. In some examples, the resources may be grant-based or grant-free (e.g., shared) resources. In some examples, the NC manager 148 may further provide an indication enabling (activating) a network coding feature for each of the one or more resource pools. In some examples, the NC manager 148 may enable (activate) the network coding feature for one or more of the resource pools, may enable (activate) the network coding feature for one or more resource pools for a duration, or may enable (activate) the network coding feature for one or more of the resource pools until a disable (deactivation) indication is provided. In other examples, the NC managers 144 and 150 within the UEs 138 and 140 may activate or deactivate the network coding feature for a resource pool. In some examples, the NC manager 148 may further configure one or more patterns for network coded sidelink transmissions. The patterns may be configured per resource pool or for all resource pools.

In some examples, the NC manager 148 may schedule the resource for the network coded sidelink transmission and provide an indication of the scheduled resource within, for example, downlink control information (DCI) to the UE 138. The NC manager 148 may further provide the pattern for the network coded sidelink transmission in the DCI, or the UE 138 (e.g., NC manager 144) may select the pattern from configured patterns for the resource pool containing the scheduled resource.

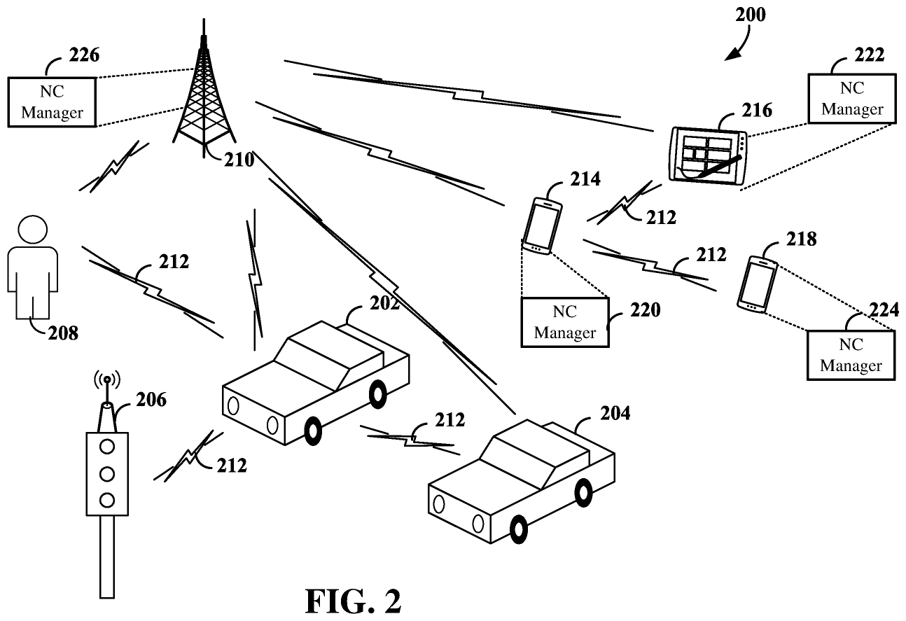

FIG. 2 illustrates an example of a wireless communication network 200 configured to support sidelink communication. In some examples, sidelink communication may include V2X communication. V2X communication involves the wireless exchange of information directly between not only vehicles (e.g., vehicles 202 and 204) themselves, but also directly between vehicles 202/204 and infrastructure (e.g., roadside units (RSUs) 206), such as streetlights, buildings, traffic cameras, tollbooths or other stationary objects, vehicles 202/204 and pedestrians 208, and vehicles 202/204 and wireless communication networks (e.g., network entity 210). The network entity 210 may be, for example, any base station (e.g., gNB, eNB) or other scheduling entity as illustrated in FIG. 1. The network entity 210 may further be implemented in an aggregated or monolithic base station architecture, or in a disaggregated base station architecture. In addition, the network entity 210 may be a stationary network entity or a mobile network entity. In some examples, V2X communication may be implemented in accordance with the New Radio (NR) cellular V2X standard defined by 3GPP, Release 16, or other suitable standard.

V2X communication enables vehicles 202 and 204 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 202 and 204 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian/cyclist 208 may be utilized to trigger a warning sound, vibration, flashing light, etc., in case of imminent danger.

The sidelink communication between vehicle-UEs (V-UEs) 202 and 204 or between a V-UE 202 or 204 and either an RSU 206 or a pedestrian-UE (P-UE) 208 may occur over a sidelink 212 utilizing a proximity service (ProSe) PC5 interface. In various aspects of the disclosure, the PC5 interface may further be utilized to support D2D sidelink 212 communication in other proximity use cases. Examples of other proximity use cases may include public safety or commercial (e.g., entertainment, education, office, medical, and/or interactive) based proximity services. In the example shown in FIG. 2, ProSe communication may further occur between UEs 214, 216, and 218.

ProSe communication may support different operational scenarios, such as in-coverage, out-of-coverage, and partial coverage. Out-of-coverage refers to a scenario in which UEs are outside of the coverage area of a network entity (e.g., network entity 210), but each are still configured for ProSe communication. Partial coverage refers to a scenario in which some of the UEs are outside of the coverage area of the network entity 210, while other UEs are in communication with the network entity 210. In-coverage refers to a scenario in which UEs are in communication with the network entity 210 (e.g., gNB) via a Uu (e.g., cellular interface) connection to receive ProSe service authorization and provisioning information to support ProSe operations.

In some examples, a UE (e.g., UE 218) may not have a Uu connection with the network entity 210. In this example, a D2D relay link (over sidelink 212) may be established between UE 218 and UE 214 to relay communication between the UE 218 and the network entity 210. The relay link may utilize decode and forward (DF) relaying, amplify and forward (AF) relaying, or compress and forward (CF) relaying. For DF relaying, HARQ feedback may be provided from the receiving device to the transmitting device. The sidelink communication over the relay link may be carried, for example, in a licensed frequency domain using radio resources operating according to a 5G NR or NR sidelink (SL) specification and/or in an unlicensed frequency domain, using radio resources operating according to 5G new radio-unlicensed (NR-U) specifications. The relay link between UE 214 and UE 218 may be established due to, for example, distance or signal blocking between the network entity 210 and the UE 218, weak receiving capability of the UE 218, low transmission power of the UE 218, limited battery capacity of the UE 218, and/or to improve link diversity. Thus, the relay link may enable communication between the network entity 210 and UE 218 to be relayed via one or more relay UEs (e.g., UE 214) over a Uu wireless communication link and relay link(s) (e.g., between UE 214 and UE 218). In other examples, a relay link may enable sidelink communication to be relayed between a UE (e.g., UE 218) and another UE (e.g., UE 216) over various relay links (e.g., relay links between UEs 214 and 216 and between UEs 214 and 218).

To facilitate D2D sidelink communication between, for example, UEs 214 and 216 over the sidelink 212, the UEs 214 and 216 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 212. For example, the discovery signal may be utilized by the UE 216 to measure the signal strength and channel status of a potential sidelink (e.g., sidelink 212) with another UE (e.g., UE 214). The UE 216 may utilize the measurement results to select a UE (e.g., UE 214) for sidelink communication or relay communication.

In some examples, a common carrier may be shared between the sidelinks 212 and Uu links, such that resources on the common carrier may be allocated for both sidelink communication between UEs (e.g., UEs 202, 204, 207, 208, 214, 216, and 218) and cellular communication (e.g., uplink and downlink communication) between the UEs (e.g., UEs 202, 204, 206, 208, 214, 216, and 218) and the network entity 210. In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. The number of sub-channels in a resource pool may include between one and twenty-seven sub-channels. A radio resource control (RRC) configuration of the resource pools may be either pre-configured (e.g., a factory setting on the UE determined, for example, by sidelink standards or specifications) or configured by a network entity (e.g., network entity 210).

In addition, there may be two main resource allocation modes of operation for sidelink (e.g., PC5) communications. In a first mode, Mode 1, a network entity (e.g., gNB) 210 may allocate resources to sidelink devices (e.g., V2X devices or other sidelink devices) for sidelink communication between the sidelink devices in various manners. For example, the network entity 210 may allocate sidelink resources dynamically (e.g., a dynamic grant) to sidelink devices, in response to requests for sidelink resources from the sidelink devices. For example, the network entity 210 may schedule the sidelink communication via DCI 2_0. In some examples, the network entity 210 may schedule the PSCCH/PSSCH within uplink resources indicated in DCI 2_0. The network entity 210 may further activate preconfigured sidelink grants (e.g., configured grants) for sidelink communication among the sidelink devices. In some examples, the network entity 210 may activate a configured grant (CG) via RRC signaling. In Mode 1, sidelink feedback may be reported back to the network entity 210 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1 may include information for resource allocation of a sidelink resource and for decoding of the second stage of sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may be transmitted within the PSSCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

In some examples, the SCI (e.g., SCI-1 and/or SCI-2) may further include a resource assignment of retransmission resources reserved for one or more retransmissions of the sidelink transmission (e.g., the sidelink traffic/data). Thus, the SCI may include a respective PSSCH resource reservation and assignment for one or more retransmissions of the PSSCH. For example, the SCI may include a reservation message indicating the PSSCH resource reservation for the initial sidelink transmission (initial PSSCH) and one or more additional PSSCH resource reservations for one or more retransmissions of the PSSCH.

In some examples, one or more of the UEs (e.g., UE 214, 216, and UE 218) may support network coding. In this example, each of the UEs 214, 216, and 218 may include a network coding (NC) manager 220, 222, and 224, respectively, configured to form a network coding group including the UEs 214, 216, and 218. For example, the NC managers 220, 222, and 224 may be configured to exchange sidelink messages between the UEs 214, 216, and 218 over a sidelink channel (e.g., sidelink 212) to form a network coding group based on the capability of each of the UEs 214, 216, and 218 to support network coding. Upon establishing the network coding group, one of the UEs (e.g., UE 214) may transmit a network coded sidelink transmission including transport blocks associated with at least two initial sidelink transmissions to one or more other UEs in the network coding group (e.g., UEs 216 and 218). For example, UE 214 may transmit a first sidelink transmission including a first transport block to the UE 216, and may further transmit a second sidelink transmission including a second transport block to the UE 218. The NC manager 220 within the UE 214 may then transmit a network coded sidelink transmission including the first and second transport blocks to the UEs 214 and 216. As another example, UE 214 may transmit the first sidelink transmission including the first transport block to the UE 216, and the UE 216 may transmit a third sidelink transmission including a third transport block to the UE 218. In this example, the NC manager 222 within the UE 216 may further transmit the third sidelink transmission to the UE 214 or the NC manager 220 within the UE 214 may listen to the sidelink channel to receive the third sidelink transmission. The NC manager 220 may then transmit a network coded sidelink transmission including the first and second transport blocks to the UEs 216 and 218. Other combinations of initial sidelink transmissions within the network coding group may further be used to generate the network coded sidelink transmission.

The UE 214 may transmit the network coded sidelink transmission on a resource (e.g., time-frequency resource). In some examples, the NC manager 220 within the UE 214 may select the resource for the network coded sidelink transmission. For example, the NC manager 220 may select the resource from a resource pool configured for sidelink communication generally or from a resource pool dedicated for network coded sidelink communication. In some examples, the NC manager 220 may further select a pattern (e.g., a sequence of sidelink transmissions) associated with the network coded sidelink transmission. The NC manger 220 within the UE 214 may then transmit the network coded sidelink transmission as part of the pattern for network coded sidelink transmissions.

The resource pool used for the network coded sidelink transmission may be pre-configured (e.g., via one or more standards or specifications) or may be configured by the network entity 210. For example, the network entity 210 may further include an NC manager 226 configured to provide a resource allocation of a plurality of resources (e.g., one or more resource pools) dedicated for network coded sidelink transmissions. In some examples, the resources may be grant-based or grant-free (e.g., shared) resources. In some examples, the NC manager 226 may further provide an indication enabling (activating) a network coding feature for each of the one or more resource pools. In some examples, the NC manager 226 may enable (activate) the network coding feature for one or more of the resource pools, may enable (activate) the network coding feature for one or more resource pools for a duration, or may enable (activate) the network coding feature for one or more of the resource pools until a disable (deactivation) indication is provided. In other examples, the UEs 214, 216, and 218 may activate or deactivate the network coding feature for a resource pool. In some examples, the NC manager 226 may further configure one or more patterns for network coded sidelink transmissions. The patterns may be configured per resource pool or for all resource pools.

In some examples, the NC manager 226 may schedule the resource for the network coded sidelink transmission and provide an indication of the scheduled resource within, for example, downlink control information (DCI) to the UE 214. The NC manager 226 may further provide the pattern for the network coded sidelink transmission in the DCI, or the NC manager 220 within the UE 214 may select the pattern from configured patterns for the resource pool containing the scheduled resource.

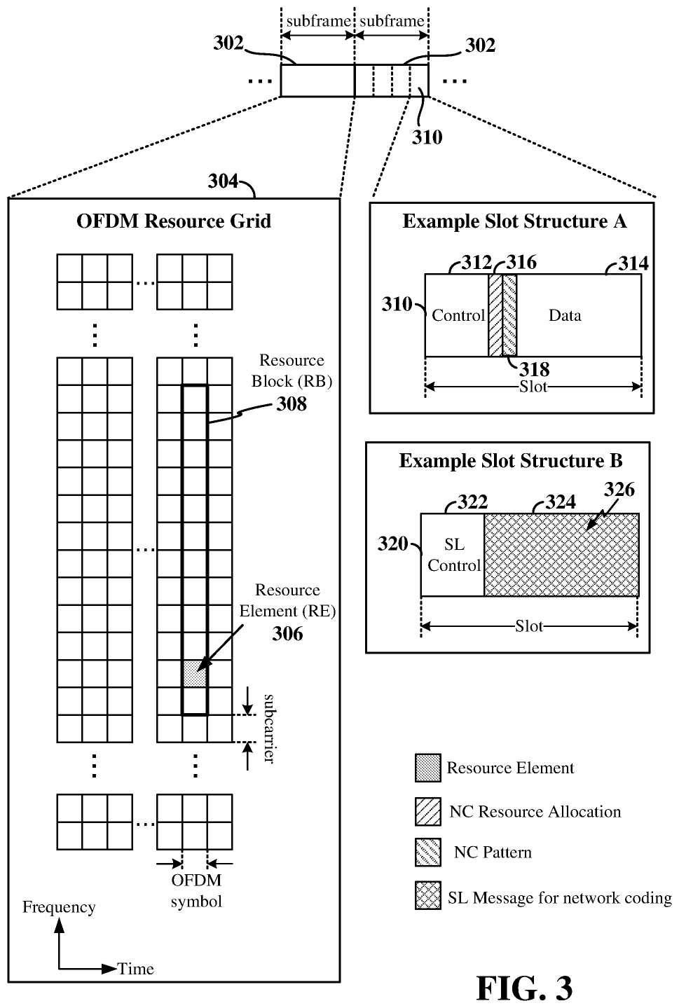

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 13 subcarriers, a number independent of the numerology used. In some examples, depending on the numerology, an RB may include any suitable number of consecutive OFDM symbols in the time domain.

A set of continuous or discontinuous resource blocks may be referred to herein as a Resource Block Group (RBG), sub-band, or bandwidth part (BWP). A set of sub-bands or BWPs may span the entire bandwidth. Scheduling of wireless communication devices (e.g., V2X devices, sidelink devices, or other UEs, hereinafter generally referred to as UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity (e.g., gNB, eNB, etc.) or may be self-scheduled by a UE/sidelink device implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310 or 320, as an illustrative example. In some examples, a slot may be defined according to a specified number of OFDM symbols with a given cyclic prefix (CP) length. For example, a slot may include 7 or 13 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

Expanded views of slots 310 and 320 each illustrates that the slot 310 or 320 includes a control region 312 or 322 and a data region 314 or 324. In general, the control region 312 or 322 may carry control channels, and the data region 314 or 324 may carry data channels. Slot 310 represents a Uu slot carrying DL and/or UL control and/or data, while slot 320 represents a sidelink slot carrying sidelink control and/or data. In some examples, a Uu slot (e.g., slot 310) may contain all DL, all UL, or at least one DL portion and at least one UL portion. The structures illustrated in FIG. 3 are merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, a slot 310 or 320 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a network entity) may allocate one or more REs 306 (e.g., within the control region 312) of the Uu slot 310 to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 306 (e.g., in the control region 312 or the data region 314) of the Uu slot 310 to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 30, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information.

In an UL transmission, the scheduled entity (e.g., UE) may utilize one or more REs 306 of the Uu slot 310 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, a measurement report (e.g., a Layer 1 (L1) measurement report), or any other suitable UCI.

In addition to control information, one or more REs 306 (e.g., within the data region 314) of the Uu slot 310 may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIB s and DMRSs. In some examples, the PDSCH may carry a plurality of SIBs, not limited to SIB1, discussed above. For example, the OSI may be provided in these SIBs, e.g., SIB3 and above.

In various aspects, as shown in FIG. 3, the Uu slot 310 may further include a network coding (NC) resource allocation 316 that may be provided by the network entity to a plurality of wireless communication devices (e.g., a plurality of UEs) in a network coding group configured for coordinated sidelink network coding. In some examples, the NC resource allocation 316 may include of a plurality of resources dedicated for network coded sidelink transmissions from a network entity. The resources may be grant-based or grant-free (e.g., shared) resources. For example, the plurality of resources may include one or more resource pools. In some examples, the NC resource allocation 316 may include an indication enabling (activating) a network coding feature for one or more of the resource pools. In some examples, the indication may enable the one or more resource pools for a duration or until a disable (deactivation) indication is provided. In other examples, the indication enabling the network coding feature may be sent via a different message. For example, the NC resource allocation 316 may be sent via a radio resource control (RRC) message, while the indication enabling the network coding feature may be sent via a medium access control (MAC) control element (MAC-CE) or via DCI.

In some examples, the Uu slot 310 may further include one or more NC patterns 318 configured per resource pool or for all resource pools. In some examples, the NC resource allocation 316 may include the NC pattern(s) configured for the NC resource allocation 316. In other examples, the NC pattern(s) 318 may be provided separate from the NC resource allocation 316. For example, the NC resource allocation may be provided within an RRC message, and the NC pattern(s) 318 for one or more resource pools may be provided within a MAC-CE or DCI.

In an example of sidelink communication over a sidelink carrier via a PC5 interface, the control region 322 of the sidelink slot 320 may carry sidelink (SL) control. The SL control may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 324 of the sidelink slot 320 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within the sidelink slot 320. For example, sidelink MAC-CEs may be transmitted in the data region 324 of the slot 320. In addition, HARQ feedback information may be transmitted in a physical sidelink feedback channel (PSFCH) within the slot 320 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 320.

In various aspects, as shown in FIG. 3, the data region 324 of the sidelink slot 320 may carry a sidelink message 326 for network coding. In some examples, the sidelink message 326 may correspond to a network coding group sidelink message transmitted by a Tx sidelink device to form a network coding group with one or more Rx sidelink devices. For example, the sidelink message 326 may include a capability of the Tx sidelink device to support network coding. In other examples, the sidelink message 326 may correspond to a network coded sidelink transmission including multiple transport blocks associated with multiple initial sidelink transmissions from one or more sidelink devices within the network coding group.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

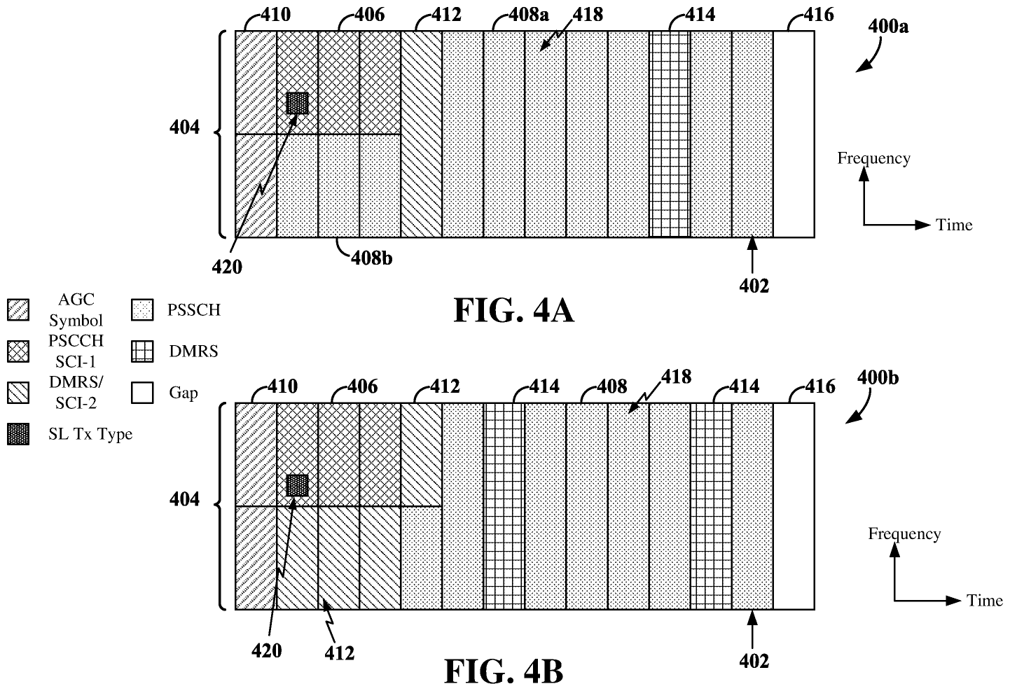

FIGS. 4A and 4B are diagrams illustrating examples of sidelink slot structures according to some aspects. The sidelink slot structures may be utilized, for example, in a V2X or other D2D network implementing sidelink. In the examples shown in FIGS. 4A and 4B, time is in the horizontal direction with units of symbols 402 (e.g., OFDM symbols); and frequency is in the vertical direction. Here, a carrier bandwidth 404 allocated for sidelink wireless communication is illustrated along the frequency axis. The carrier bandwidth 404 may include a plurality of sub-channels, where each sub-channel may include a configurable number of PRBs (e.g., 10, 15, 20, 25, 50, 75, or 100 PRBs).

Each of FIGS. 4A and 4B illustrate an example of a respective slot 400a or 400b including fourteen symbols 402 that may be used for sidelink communication. However, it should be understood that sidelink communication can be configured to occupy fewer than fourteen symbols in a slot 400a or 400b, and the disclosure is not limited to any particular number of symbols 402. Each sidelink slot 400a and 400b includes a physical sidelink control channel (PSCCH) 406 occupying a control region of the slot 400a and 400b and a physical sidelink shared channel (PSSCH) 408 occupying a data region of the slot 400a and 400b. The PSCCH 406 and PSSCH 408 are each transmitted on one or more symbols 402 of the slot 400a. The PSCCH 406 includes, for example, SCI-1 that schedules transmission of data traffic on time-frequency resources of the corresponding PSSCH 408. As shown in FIGS. 4A and 4B, the PSCCH 406 and corresponding PSSCH 408 are transmitted in the same slot 400a and 400b. In other examples, the PSCCH 406 may schedule a PSSCH in a subsequent slot.

In some examples, the PSCCH 406 duration is configured to be two or three symbols. In addition, the PSCCH 406 may be configured to span a configurable number of PRBs, limited to a single sub-channel. The PSCCH resource size may be fixed for a resource pool (e.g., 10% to 100% of one sub-channel in the first two or three symbols). For example, the PSCCH 406 may occupy 10, 12, 15, 20, or 25 RBs of a single sub-channel. In each of the examples shown in FIGS. 4A and 4B, the starting symbol for the PSCCH 406 is the second symbol of the corresponding slot 400a or 400b and the PSCCH 406 spans three symbols 402. The PSCCH 406 may further include DMRSs.

The PSSCH 408 may be time-division multiplexed (TDMed) with the PSCCH 406 and/or frequency-division multiplexed (FDMed) with the PSCCH 406. In the example shown in FIG. 4A, the PSSCH 408 includes a first portion 408a that is TDMed with the PSCCH 406 and a second portion 408b that is FDMed with the PSCCH 406. In the example shown in FIG. 4B, the PSSCH 408 is TDMed with the PSCCH 406.

One- and two-layer transmissions of the PSSCH 408 may be supported with various modulation orders (e.g., QPSK, 16-QAM, 64-QAM and 256-QAM). In addition, the PSSCH 408 may include DMRSs 414 configured in a two, three, or four symbol DMRS pattern. For example, slot 400a shown in FIG. 4A illustrates a two symbol DMRS pattern, while slot 400b shown in FIG. 4B illustrates a three symbol DMRS pattern. In some examples, the transmitting UE can select the DMRS pattern and indicate the selected DMRS pattern in SCI-1, according to channel conditions. The DMRS pattern may be selected, for example, based on the number of PSSCH 408 symbols in the slot 400a or 400b. In some examples, the DMRSs 414 may be based on a Gold sequence and a configuration type 1 may be used for the frequency domain pattern of the PSSCH DMRSs 414. In addition, a gap symbol 416 is present after the PSSCH 408 in each slot 400a and 400b.

Each slot 400a and 400b further includes SCI-2 412 mapped to contiguous RBs in the PSSCH 408 starting from the first symbol containing a PSSCH DMRS. In the example shown in FIG. 4A, the first symbol containing a PSSCH DMRS is the fifth symbol occurring immediately after the last symbol carrying the PSCCH 406. Therefore, the SCI-2 412 is mapped to RBs within the fifth symbol. In the example shown in FIG. 4B, the first symbol containing a PSSCH DMRS is the second symbol, which also includes the PSCCH 406. In addition, the SCI-2/PSSCH DMRS 412 are shown spanning symbols two through five. As a result, the SCI-2/PSSCH DMRS 412 may be FDMed with the PSCCH 406 in symbols two through four and TDMed with the PSCCH 406 in symbol five.

The SCI-2 may be scrambled separately from the sidelink shared channel. In addition, the SCI-2 may utilize QPSK. When the PSSCH transmission spans two layers, the SCI-2 modulation symbols may be copied on (e.g., repeated on) both layers. The SCI-1 in the PSCCH 406 may be blind decoded at the receiving wireless communication device. However, since the format, starting location, and number of REs of the SCI-2 412 may be derived from the SCI-1, blind decoding of SCI-2 is not needed at the receiver (receiving UE).

In each of FIGS. 4A and 4B, the second symbol of each slot 400a and 400b is copied onto (repeated on) a first symbol 410 thereof for automatic gain control (AGC) settling. For example, in FIG. 4A, the second symbol containing the PSCCH 406 FDMed with the PSSCH 408b may be transmitted on both the first symbol and the second symbol. In the example shown in FIG. 4B, the second symbol containing the PSCCH 406 FDMed with the SCI-2/PSSCH DMRS 412 may be transmitted on both the first symbol and the second symbol.

In addition, in each of FIGS. 4A and 4B, the PSSCH 408 may include transport block(s) 418, which may correspond to a single transport block of an initial sidelink transmission or a retransmission thereof or to multiple transport blocks of a network coded sidelink transmission. In some examples, as shown in FIGS. 4A and 4B, the PSCCH/SCI-1 406 may include a sidelink transmission (SL Tx) type field 420 indicating whether the sidelink transmission carried within the slot 400a or 400b is a regular sidelink transmission (e.g., an initial sidelink transmission or retransmission) of a single transport block 418 or a network coded sidelink transmission of multiple transport blocks 418.

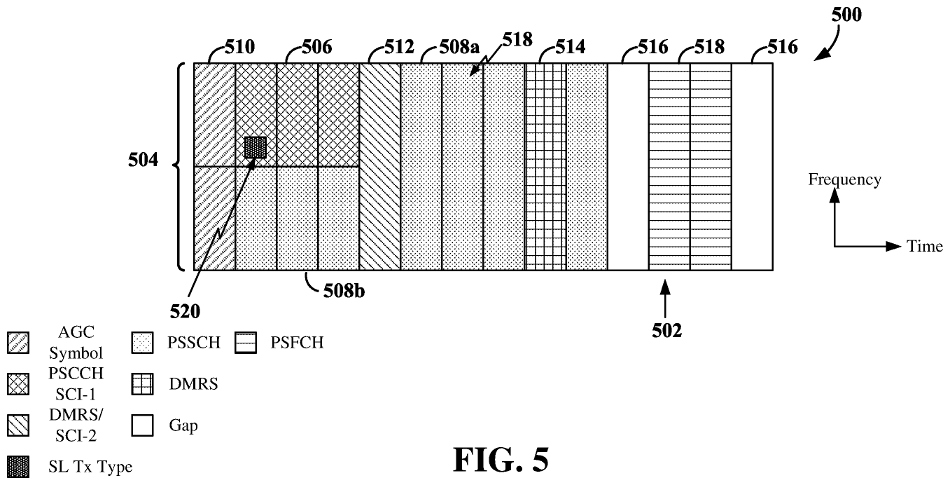

FIG. 5 is a diagram illustrating an example of a sidelink slot structure with feedback resources according to some aspects. The sidelink slot structure may be utilized, for example, in a V2X or other D2D network implementing sidelink. In the example shown in FIG. 5, time is in the horizontal direction with units of symbols 502 (e.g., OFDM symbols); and frequency is in the vertical direction. Here, a carrier bandwidth 504 allocated for sidelink wireless communication is illustrated along the frequency axis. A slot 500 having the slot structure shown in FIG. 5 includes fourteen symbols 502 that may be used for sidelink communication. However, it should be understood that sidelink communication can be configured to occupy fewer than fourteen symbols in a slot 500, and the disclosure is not limited to any particular number of symbols 502.

As in the examples shown in FIGS. 4A and 4B, the sidelink slot 500 includes a PSCCH 506 occupying a control region of the slot 500 and a PSSCH 508 occupying a data region of the slot 500. The PSCCH 506 and PSSCH 508 are each transmitted on one or more symbols 502 of the slot 500. The PSCCH 506 includes, for example, SCI-1 that schedules transmission of data traffic on time-frequency resources of the corresponding PSSCH 508. As shown in FIG. 5, the starting symbol for the PSCCH 506 is the second symbol of the slot 500 and the PSCCH 506 spans three symbols 502. The PSSCH 508 may be time-division multiplexed (TDMed) with the PSCCH 506 and/or frequency-division multiplexed (FDMed) with the PSCCH 506. In the example shown in FIG. 5, the PSSCH 508 includes a first portion 508a that is TDMed with the PSCCH 506 and a second portion 508b that is FDMed with the PSCCH 506.

The PSSCH 508 may further include DMRSs 514 configured in a two, three, or four symbol DMRS pattern. For example, slot 500 shown in FIG. 5 illustrates a two symbol DMRS pattern. In some examples, the transmitting UE can select the DMRS pattern and indicate the selected DMRS pattern in SCI-1, according to channel conditions. The DMRS pattern may be selected, for example, based on the number of PSSCH 508 symbols in the slot 500. In some examples, the DMRSs 514 may be based on a Gold sequence and a configuration type 1 may be used for the frequency domain pattern of the PSSCH DMRSs 514. In addition, a gap symbol 516 is present after the PSSCH 508 in the slot 500.

The slot 500 further includes SCI-2 512 mapped to contiguous RBs in the PSSCH 508 starting from the first symbol containing a PSSCH DMRS. In the example shown in FIG. 5, the first symbol containing a PSSCH DMRS is the fifth symbol occurring immediately after the last symbol carrying the PSCCH 506. Therefore, the SCI-2 512 is mapped to RBs within the fifth symbol.

In addition, as shown in FIG. 5, the second symbol of the slot 500 is copied onto (repeated on) a first symbol 510 thereof for automatic gain control (AGC) settling. For example, in FIG. 5, the second symbol containing the PSCCH 506 FDMed with the PSSCH 508b may be transmitted on both the first symbol and the second symbol.

In addition, as in the examples shown FIGS. 4A and 4B, the PSSCH 508a/508b may include transport block(s) 518, which may correspond to a single transport block of an initial sidelink transmission or a retransmission thereof or to multiple transport blocks of a network coded sidelink transmission. In some examples, the PSCCH/SCI-1 506 may include a sidelink transmission (SL Tx) type field 520 indicating whether the sidelink transmission carried within the slot 500 is a regular sidelink transmission (e.g., an initial sidelink transmission or retransmission) of a single transport block 518 or a network coded sidelink transmission of multiple transport blocks 518.

HARQ feedback may further be transmitted on a physical sidelink feedback channel (PSFCH) 518 in a configurable resource period of 0, 1, 2, or 4 slots. In sidelink slots (e.g., slot 500) containing the PSFCH 518, one symbol 502 may be allocated to the PSFCH 518, and the PSFCH 518 may be copied onto (repeated on) a previous symbol for AGC settling. In the example shown in FIG. 5, the PSFCH 518 is transmitted on the thirteenth symbol and copied onto the twelfth symbol in the slot 500. A gap symbol 516 may further be placed after the PSFCH symbols 518.

In some examples, there is a mapping between the PSSCH 508 and the corresponding PSFCH resource. The mapping may be based on, for example, the starting sub-channel of the PSSCH 508, the slot containing the PSSCH 508, the source ID and the destination ID. In addition, the PSFCH can be enabled for unicast and groupcast communication. For unicast, the PSFCH may include one ACK/NACK bit. For groupcast, there may be two feedback modes for the PSFCH. In a first groupcast PSFCH mode, the receiving UE transmits only NACK, whereas in a second groupcast PSFCH mode, the receiving UE may transmit either ACK or NACK. The number of available PSFCH resources may be equal to or greater than the number of UEs in the second groupcast PSFCH mode.

In some examples, in response to receiving a NACK, the transmitting UE may send a HARQ retransmission, which may implement chase combining (HARQ-CC) or incremental redundancy (HARQ-IR). In HARQ-CC, a retransmitted encoded code block (e.g., an encoded transport block) is identical to the original transmission. That is, if an encoded code block is not decoded properly at the receiving sidelink device, resulting in a NACK, then the transmitting sidelink device may retransmit the full encoded code block including identical information to the original transmission. The information may then ideally be obtained error-free by virtue of a process called soft combining, where the redundant bits from the retransmission may be combined before decoding to increase the probability of correct reception of each bit. On the other hand, in HARQ-IR, the retransmitted encoded code block may be different from the originally transmitted encoded code block, and further, if multiple retransmissions are made, each retransmission may differ from one another. Here, retransmissions may include different sets of coded bits: for example, corresponding to different code rates or algorithms; corresponding to different portions of the original code block, some of which may not have been transmitted in the original transmission; corresponding to forward error correction (FEC) bits that were not transmitted in the original transmission; or other suitable schemes. As with HARQ-CC, here, the information may be obtained error-free by utilizing soft combining to combine the retransmitted bits with the original transmitted bits.

In various aspects of the disclosure, instead of the transmitting UE initiating one or more retransmissions of the transport block based on receiving a NACK, the transmitting UE (or another UE within a network coding group including the transmitting UE) may retransmit the transport block to the one or more receiving UEs as a network coded sidelink transmission. In some examples, the network coded sidelink transmission may include the transport block and one or more additional transport blocks initially transmitted by the transmitting UE or other UEs within the network coding group. In some examples, the network coded sidelink transmission may be transmitted regardless of the feedback received. For example, the network coded sidelink transmission may be sent upon receiving either a NACK or an ACK for each of the initial sidelink transmissions.

In a 5G NR network (e.g., RAN 100), a UE may send SCI to one or more other UE(s) that includes a sidelink resource reservation. For example, a sidelink resource reservation (e.g., frequency and/or time domain resources) can be in units of sub-channels in the frequency domain and one slot in the time domain. The UE can reserve sidelink resources (e.g., each sidelink resource corresponding to one time slot and one sub-sub-channel) from a resource pool that includes resources allocated for sidelink transmission (e.g., configured by a network entity or pre-configured via one or more standards or specifications).

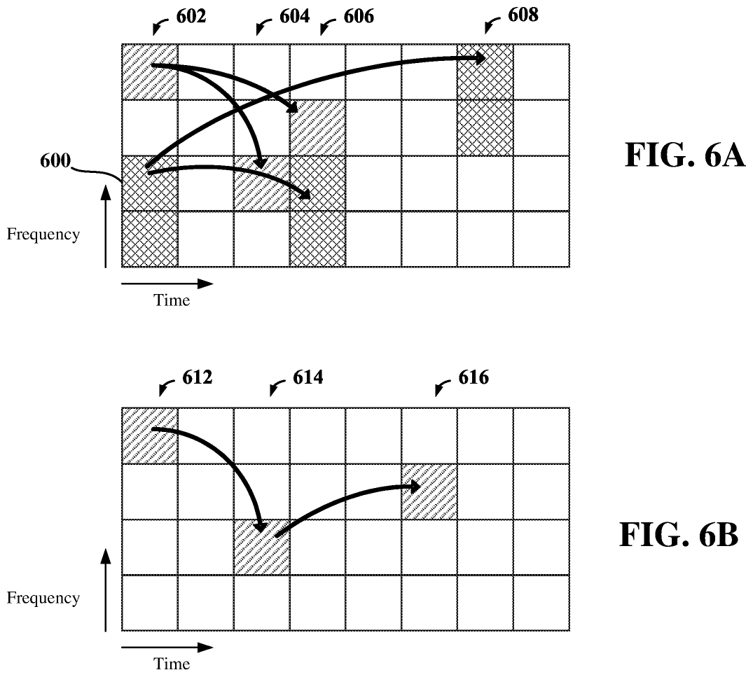

For example, as shown in FIG. 6A, a UE can reserve sidelink resources in a current slot 602 and up to two future slots (e.g., slots 604, 606, and 608). Both aperiodic and periodic resource reservations can be used in an NR sidelink network. The reserved resources can be used for the transmission of one or more transport blocks or packets (e.g., sidelink data) using one or more slots.

In some examples, as shown in FIG. 6B, a UE can reserve resources that are chained in time (e.g., frequency resources in time slots 612, 614, and 616) for the initial transmission of a transport block (TB) (e.g., in slot 612) and one or more re-transmission(s) of the TB (e.g., in slots 614 and 616) if needed. In some examples, the UE may be configured or preconfigured with a maximum number of retransmissions of a transport block (TB). Once the maximum number of retransmissions is reached, the UE can stop retransmission of the sidelink TB. In some aspects, based on the feedback of sidelink data (e.g., ACK or NACK received for a transport block (TB)), the UE may stop retransmission of the TB, for example, when the UE receives an ACK for the TB.

In some examples, instead of transmitting a retransmission of a TB, a UE can use one or more of the reserved resources for a network coded sidelink transmission. For example, a UE can transmit an initial transmission within slot 612 and then transmit a network coded sidelink transmission within slot 614. In some examples, the UE can use the reserved resources as part of a pattern (e.g., sequence) of sidelink transmissions including one or more network coded sidelink transmissions.

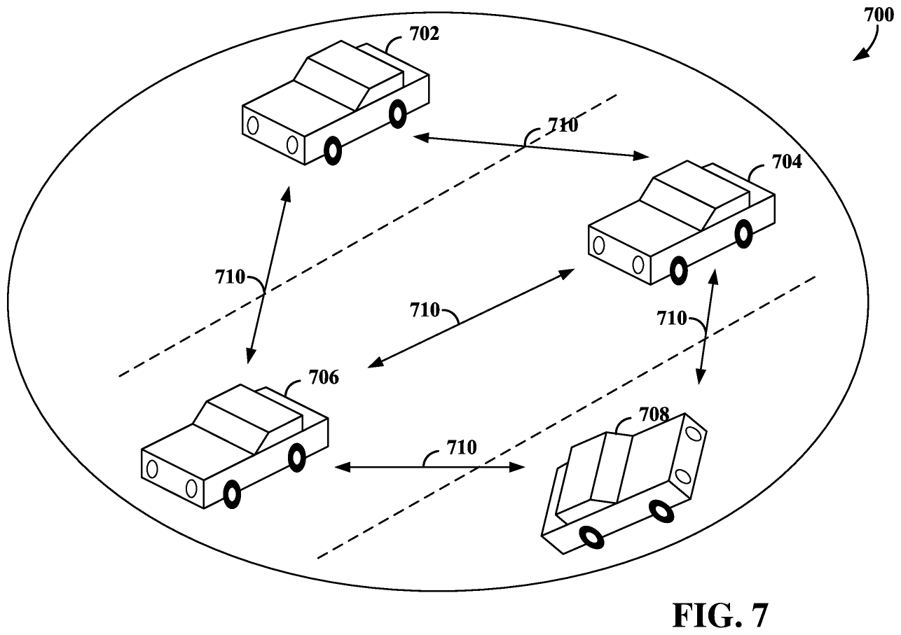

FIG. 7 is a diagram illustrating an example of the formation of a network coding group 700 according to some aspects. In the example shown in FIG. 7, four wireless communication devices 702, 704, 706, and 708 may exchange one or more sidelink messages 710 therebetween to form the network coding group 700. Although wireless communication devices 702-708 are illustrated as V-UEs, each of the wireless communication devices 702-708 may correspond to any of the UEs, sidelink devices, D2D devices, or other scheduled entities illustrated in FIGS. 1 and/or 2. The sidelink messages 710 may include, for example, a respective capability of the wireless communication devices 702-708 to support network coding (e.g., network encoding and/or network decoding). For example, a sidelink message 710 transmitted from wireless communication device 702 to wireless communication device 704 may include a capability of wireless communication device 702 to support network coding. Similarly, a sidelink message 710 transmitted from wireless communication device 704 to wireless communication device 706 may include a capability of wireless communication device 704 to support network coding, and so forth.

In some examples, the capability of a wireless communication device (e.g., wireless communication device 702) may be based, at least in part, on energy (e.g., power) available for network coding at the wireless communication device 702. For example, network encoding and decoding may be power prohibitive since joint encoding/decoding is performed and successive decoding cancellation may be performed at the decoder. The energy (e.g., power) available for network coding may vary over time. Therefore, the capability sent via a sidelink message 710 may be a dynamic capability based on an energy status of the wireless communication device. As such, the wireless communication device 702 may send sidelink messages 710 including the dynamic capability periodically or in response to a change in the capability. In examples in which the dynamic capability of the wireless communication device 702 indicates that the wireless communication device 702 no longer supports network coding, the wireless communication device 702 may be removed from the network coding group 700.

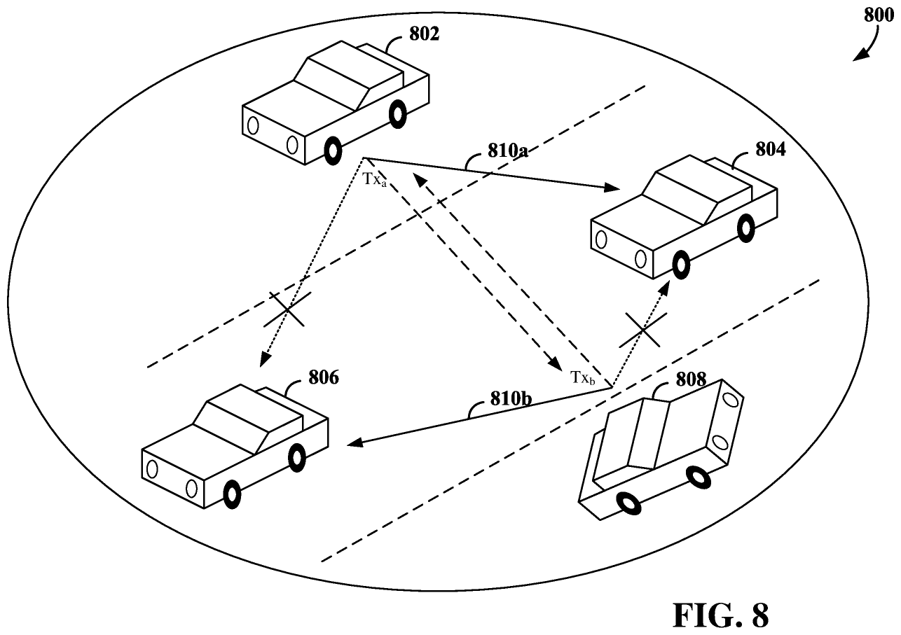

FIG. 8 is a diagram illustrating an example of initial sidelink transmissions within a network coding group 800 according to some aspects. In the example shown in FIG. 8, wireless communication devices 802, 804, 806, and 808 have formed the network coding group 800 (e.g., as described above in connection with FIG. 7). For example, wireless communication devices 802, 804, 806, and 808 may correspond, for example, to wireless communication devices 702, 704, 706, and 708 shown in FIG. 7. Although wireless communication devices 802-808 are illustrated as V-UEs, each of the wireless communication devices 802-808 may correspond to any of the UEs, sidelink devices, D2D devices, or other scheduled entities illustrated in FIGS. 1 and/or 2. A transmitting wireless communication device 802 transmits an initial sidelink transmission 810a (Txₐ) to receiving wireless communication devices 804 and 806. In addition, another transmitting wireless communication device 808 transmits another initial sidelink transmission 810b (Tx_{b}) to receiving wireless communication devices 804 and 806. In some examples, each of the initial sidelink transmissions Txₐ and Tx_{b} may be groupcast or broadcast transmissions.

The initial sidelink transmission 810a (Txₐ) is successfully received and decoded by the receiving wireless communication device 804. Thus, the receiving wireless communication device 804 may transmit an ACK (or not transmit a NACK) to the transmitting wireless communication device 802. However, the initial sidelink transmission 810a (Txₐ) is not successfully received and decoded by the receiving wireless communication device 806, resulting in the receiving wireless communication device 806 transmitting a NACK to the transmitting wireless communication device 802. In addition, the initial sidelink transmission 810b (Tx_{b}) is successfully received and decoded by the receiving wireless communication device 806. As such, the receiving wireless communication device 806 may transmit an ACK (or not transmit a NACK) to the transmitting wireless communication device 808. However, the initial sidelink transmission 810b (Tx_{b}) is not successfully received and decoded by the receiving wireless communication device 804, resulting in the receiving wireless communication device 804 transmitting a NACK to the transmitting wireless communication device 808.

In some examples, the wireless communication device 802 may further share the initial sidelink transmission 810a (Txₐ) with the remaining members of the network coding group (e.g., wireless communication device 808) or the wireless communication device 808 may listen to the sidelink channel over which the wireless communication devices 802-808 are communicating to receive the initial sidelink transmission 810a (Txₐ). In addition, the wireless communication device 808 may further share the initial sidelink transmission 810b (Tx_{b}) with the remaining members of the network coding group (e.g., wireless communication device 802) or the wireless communication device 802 may listen to the sidelink channel over which the wireless communication devices 802-808 are communicating to receive the initial sidelink transmission 810b (Tx_{b}).

In various aspects, one or more of the wireless communication devices 802 and 808 that initiated any/or successfully decoded the initial sidelink transmissions 810a and 810b may transmit a network coded sidelink transmission including the respective transport blocks associated with each of the initial sidelink transmissions 810a and 810b. For example, one or both of wireless communication devices 802 and 808 may transmit a network coded sidelink transmission including the respective transport blocks associated with each of the initial sidelink transmissions 810a and 810b.

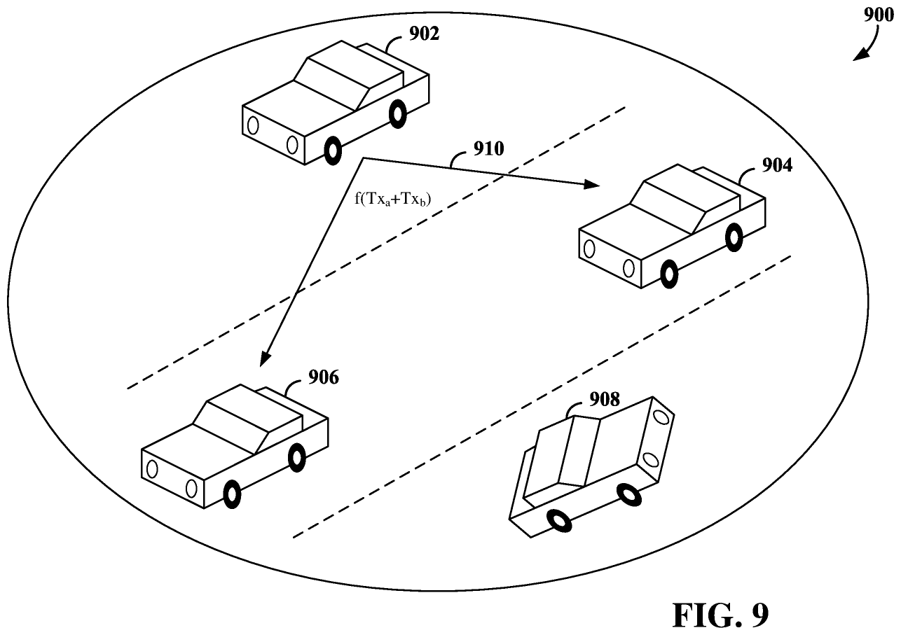

FIG. 9 is a diagram illustrating an example of a network coded sidelink transmission within a network coding group 900 according to some aspects. In the example shown in FIG. 9, the network coding group 900 includes wireless communication devices 902, 904, 906, and 908, which may correspond, for example, to wireless communication devices 802, 804, 806, and 808 shown in FIG. 8. Although wireless communication devices 902-908 are illustrated as V-UEs, each of the wireless communication devices 902-908 may correspond to any of the UEs, sidelink devices, D2D devices, or other scheduled entities illustrated in FIGS. 1 and/or 2.

In the example shown in FIG. 9, the wireless communication device 902 may be configured to retransmit sidelink transmissions Txₐ and Tx_{b} (e.g., as shown in FIG. 8) as a network coded sidelink transmission 910. In some examples, the network coded sidelink transmission 910 may be a function (e.g., XOR) of each of the initial sidelink transmissions (f(Txₐ, Tx_{b})). In some examples, the wireless communication device 902 may utilize erasure coding as the function to generate the network coded sidelink transmission. With erasure coding, a receiving wireless communication device (e.g., wireless communication device 904) may recover an erased (incorrectly decoded) transmission by summing the other correctly decoded transmissions. For example, if the network coded sidelink transmission corresponds to Txₐ⊕Tx_{b} and the receiving wireless communication device 904 previously correctly decoded Txₐ, the receiving wireless communication device 904 can recover the erased Tx_{b} by summing Txₐ with the network coded sidelink transmission Txₐ⊕Tx_{b} as follows: Txₐ⊕(Txₐ⊕Tx_{b}). Similarly, receiving wireless communication device 906 may recover erased (incorrectly decoded) sidelink transmission Txₐ by summing correctly received Tx_{b} with the network coded sidelink transmission Txₐ⊕Tx_{b} as follows: Tx_{b}⊕(Txₐ⊕Tx_{b}).

The wireless communication device 902 may further utilize any type of channel coding for subsequently encoding the network coded sidelink transmission 910 (e.g., after network coding, the wireless communication device may encode the network coded sidelink transmission using any suitable channel coding mechanism). By way of example, but not limitation, the wireless communication device 902 may utilize turbo coding, low density parity check (LDPC) coding, polar coding, etc. to encode the network coded sidelink transmission 910.

The receiving wireless communication devices 904 and 906 may receive the network coded sidelink transmission 910 and attempt to decode the initial sidelink transmission(s) (e.g., Txₐ and/or Tx_{b}) based on the network coded sidelink transmission. Using the example shown in FIG. 9, the receiving wireless communication device 904 may be able to decode Tx_{b} from the network coded sidelink transmission (f(Txₐ, Tx_{b})) and the originally decoded initial sidelink transmission Txₐ. In addition, the receiving wireless communication device 906 may be able to decode Txₐ from the network coded sidelink transmission (f(Txₐ, Tx_{b})) and the originally decoded initial sidelink transmission Tx_{b}.

Generally, erasure coding using a single parity check code may be used to recover one erasure (e.g., one incorrectly decoded sidelink transmission). For example, for three initial sidelink transmissions a, b, and c, the network coded sidelink transmission may be encoded as [a⊕b⊕c]. From this, any single erasure may be recovered. For example, if the received vector is [a, ?, c, a⊕b⊕c], the erased element may be recovered by summing the others: a⊕c⊕(a⊕b⊕c)=b. This can be viewed as a linear system (over a Galois field) with three variables and four linearly independent constraints:

$$[ \begin{matrix}100 \\ 010 \\ 001 \\ 111\end{matrix} ] \cdot {[ \begin{matrix}a & b & c\end{matrix} ]}^{T} = [ a , b , c , a ⊕ b ⊕ c ] . \qquad ( Equation 1 )$$

Any three constraints (with one erasure) are sufficient to find the three variables.

For two or more erasures, an extension of the single parity example above may be used. For example, Reed-Solomon or other maximum distance separable (MDS) code may be used, such that k symbols of an n symbol codeword are sufficient to decode the k information symbols. An example encoding to recover from up to two erasures may be as follows:

$$[ \begin{matrix}100 \\ 010 \\ 001 \\ 111 \\ 1 {αα}^{2}\end{matrix} ] \cdot {[ \begin{matrix}a & b & c\end{matrix} ]}^{T} = {[ a , b , c , a + b + c , a + α \cdot b + {α}^{2} \cdot c ]}^{T} . \qquad ( Equation 2 )$$

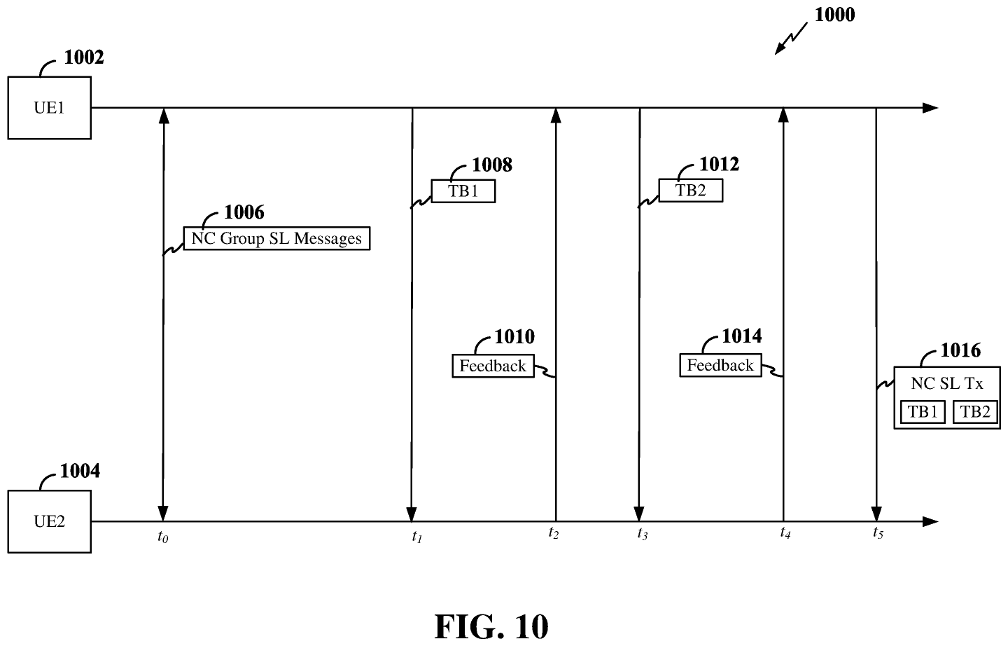

FIG. 10 is a signaling diagram illustrating exemplary signaling between wireless communication devices 1002 and 1004 for sidelink network coding according to some aspects. The wireless communication device 1002 may correspond to a transmitting (Tx) UE and wireless communication device 1004 may correspond to a receiving (Rx) UE. Tx UE 1002 and Rx UE 1004 may correspond to any of the UEs, sidelink devices, V2X devices, D2D devices, or other scheduled entities illustrated in any of FIGS. 1, 2, and/or 7-9. In some examples, the Rx UE 1004 may represent one or more Rx UEs of an initial sidelink transmission by the Tx UE 1002.

At an initial time (t₀), the Tx UE 1002 and Rx UE 1004 may exchange sidelink messages 1006 to form a network coding group. For example, each of Tx UE 1002 and Rx 1004 may exchange a respective capability thereof indicating that each of the Tx UE 1002 and Rx UE 1004 support network coding.

At a first time (t₁), the Tx UE 1002 may transmit a first initial sidelink transmission 1008 including a first transport block (TB1). In some examples, the first initial sidelink transmission 1008 may be transmitted over a sidelink data channel (e.g., a PSSCH). The first initial sidelink transmission including the TB1 may be transmitted to one or more Rx UEs 1004 (only one of which is shown for convenience). For example, the first initial sidelink transmission 1008 may be a unicast, groupcast, or broadcast transmission destined for the one or more Rx UEs 1004.

At a second time (t₂), the Rx UE 1004 (and each other Rx UE to which the first initial sidelink transmission 1008 is destined) may transmit first feedback information 1010 (e.g., HARQ ACK/NACK) to the Tx UE 1002 indicating whether the Rx UE 1004 was able to successfully decode TB1.

At a third time (t₃), the Tx UE 1002 may transmit a second initial sidelink transmission 1012 including a second transport block (TB2). The second initial sidelink transmission including the TB2 may again be transmitted to one or more Rx UEs 1004 and may be a unicast, groupcast, or broadcast transmission destined for the one or more Rx UEs 1004. At a fourth time (t₄), the Rx UE 1004 (and each other Rx UE to which the second initial sidelink transmission 1012 is destined) may transmit second feedback information 1014 (e.g., HARQ ACK/NACK) to the Tx UE 1002 indicating whether the Rx UE 1004 was able to successfully decode TB2.

At a fifth time (t₅), the Tx UE 1002 may transmit a network coded sidelink transmission to the one or more Rx UEs 1004 including TB1 and TB2. In some examples, the network coded sidelink transmission may be a function (e.g., XOR) of TB1 and TB2. For example, the Tx UE 1002 may use erasure coding, such as a single parity check code or a MDS code, to generate the network coded sidelink transmission. In some examples, the Tx UE 1002 may transmit the network coded sidelink transmission in response to receiving a NACK within at least one of feedback 1010 or feedback 1014. In other examples, the Tx UE 1002 may transmit the network coded sidelink transmission regardless of whether an ACK or NACK is received within feedback 1010 and feedback 1014.

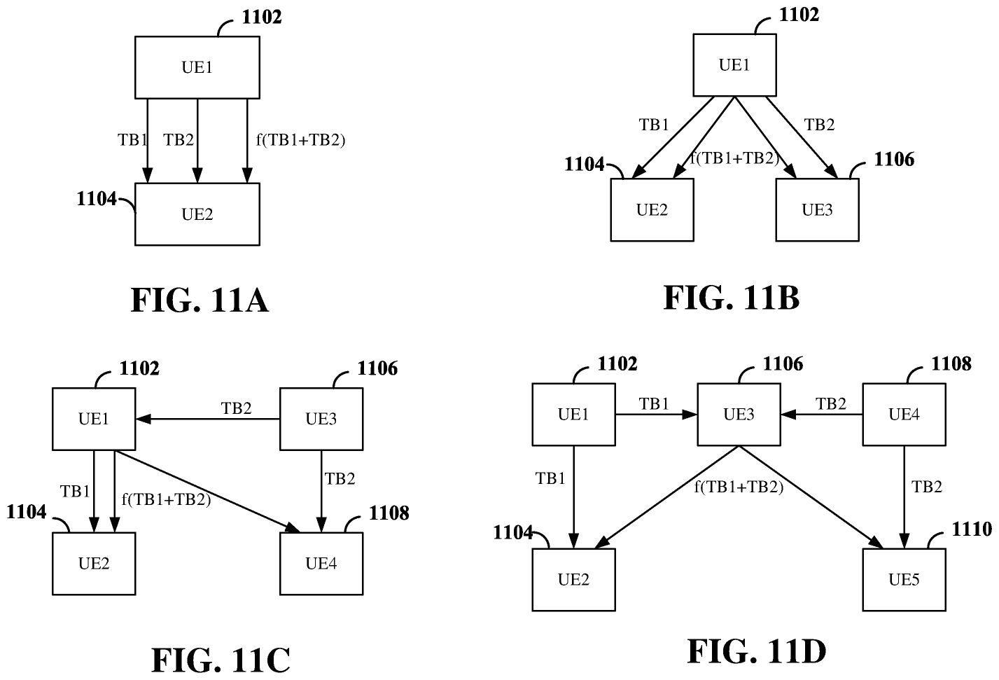

FIGS. 11A-11D are diagrams illustrating examples of network coded sidelink transmissions between wireless communication devices (e.g., UEs) within network coding groups according to some aspects. In the example shown in FIG. 11A, a transmitting UE (UE1) 1102 is in a network coding group with a receiving UE (UE2 1104). The UE1 1102 can transmit a first transport block (TB1) within a first initial sidelink transmission to UE2 1104 and a second transport block (TB2) within a second initial sidelink transmission to UE2 1104. The UE1 1102 can then transmit a network coded sidelink transmission including TB1 and TB2 (e.g., f(TB1+TB2)) to UE2 1104 to facilitate decoding of TB1 and TB2 at UE2 1104. In some examples, the UE1 1102 may transmit the network coded sidelink transmission in response to receiving a NACK for one or both of TB1 and TB2. In other examples, the UE1 1102 may transmit the network coded sidelink transmission regardless of whether an ACK or NACK is received for TB1 and TB2.

In the example shown in FIG. 11B, a transmitting UE (UE1) 1102 is in a network coding group with receiving UEs (UE2 1104 and UE3 1106). The UE1 1102 can transmit a first transport block (TB1) within a first initial sidelink transmission to UE2 1104 and a second transport block (TB2) within a second initial sidelink transmission to UE3 1106. The UE1 1102 can then transmit a network coded sidelink transmission including TB1 and TB2 (e.g., f(TB1+TB2)) to UE2 1104 and UE3 1106 to facilitate decoding of TB1 at UE2 1104 and TB2 at UE3 1106. In some examples, the UE1 1102 may transmit the network coded sidelink transmission in response to receiving a NACK for one or both of TB1 and TB2. In other examples, the UE1 1102 may transmit the network coded sidelink transmission regardless of whether an ACK or NACK is received for TB1 and TB2.

In the example shown in FIG. 11C, there are four UEs (UE1 1102, UE2 1104, UE3 1106, and UE4 1108) in a network coding group. The UE1 1102 can transmit a first transport block (TB1) within a first initial sidelink transmission to UE2 1104. In addition, the UE3 1106 can transmit a second transport block (TB2) within a second initial sidelink transmission to UE4 1108. In some examples, the UE3 1106 can further share TB2 with the UE1 1102 (e.g., the UE3 1106 can transmit the second initial sidelink transmission to UE1 1102 and UE4 1108 or can transmit a copy of the TB2 within another sidelink communication to UE1 1102). In other examples, the UE1 1102 can listen to a sidelink channel to receive the second initial sidelink transmission from the UE3 1106. The UE1 1102 can then transmit a network coded sidelink transmission including TB1 and TB2 (e.g., f(TB1+TB2)) to UE2 1104 and UE4 1108 to facilitate decoding of TB1 at UE2 1104 and TB2 at UE4 1108. In some examples, the UE1 1102 may transmit the network coded sidelink transmission in response to at least one of receiving a NACK for TB1 or to receiving or listening to the sidelink channel for a NACK for TB2. In other examples, the UE1 1102 may transmit the network coded sidelink transmission regardless of whether an ACK or NACK is received for TB1 and TB2.

In the example shown in FIG. 11D, there are five UEs (UE1 1102, UE2 1104, UE3 1106, UE4 1108, and UE5 1110) in a network coding group. The UE1 1102 can transmit a first transport block (TB1) within a first initial sidelink transmission to UE2 1104. In addition, the UE4 1108 can transmit a second transport block (TB2) within a second initial sidelink transmission to UE5 1110. In some examples, each of UE1 1102 and UE4 1108 can further share their respective TBs (TB1 and TB2) with the UE3 1106 or the UE3 1106 can listen to a sidelink channel to receive the first and second initial sidelink transmissions from UE1 1102 and UE4 1108. The UE3 1106 can then transmit a network coded sidelink transmission including TB1 and TB2 (e.g., f(TB1+TB2)) to UE2 1104 and UE5 1110 to facilitate decoding of TB1 at UE2 1104 and TB2 at UE5 1110. In some examples, the UE3 1106 may transmit the network coded sidelink transmission in response to at least one of receiving a NACK for TB1 or to receiving or listening to the sidelink channel for a NACK for TB2. In other examples, the UE3 1106 may transmit the network coded sidelink transmission regardless of whether an ACK or NACK is received for TB1 and TB2.

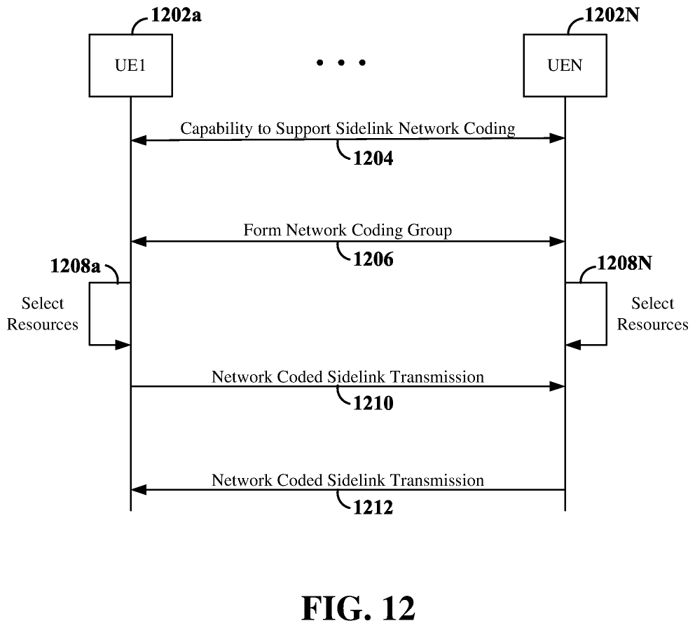

FIG. 12 is a signaling diagram illustrating other exemplary signaling between wireless communication devices (e.g., UE1 1202a UEN 1202N) for sidelink network coding according to some aspects. Each of the UEs 1202a . . . 1202N may correspond to any of the UEs, sidelink devices, V2X devices, D2D devices, or other scheduled entities illustrated in any of FIGS. 1, 2, and/or 7-11. In addition, each of the UEs 1202a . . . 1202N may communicate using Mode 2 sidelink communication, in which the UEs 1202a . . . 1202N may autonomously select resources for sidelink communication therebetween.

At 1204, the UEs 1202a . . . 1202N may exchange sidelink messages indicating a respective capability of each of the UEs 1202a . . . 1202N to support sidelink network coding. In some examples, the capability of a wireless communication device (e.g., UE 1202a) may be based, at least in part, on energy (e.g., power) available for network coding at the UE 1202a. Therefore, the capability sent via a sidelink message may be a dynamic capability based on an energy status of the respective UE 1202a . . . 1202N.

At 1206, the UEs 1202a . . . 1202N may form a network coding group based on the respective capabilities of each of the UEs 1202a . . . 1202N. In some examples, the UEs 1202a . . . 1202N may further agree upon a resource pool to use for network coding via the sidelink messages and/or may activate or deactivate a network coding feature for a resource pool. For example, the UEs 1202a . . . 1202N may select the resource pool and/or configure the resource pool for network coding (e.g., by activating or deactivating a network coding feature) using SCI, sidelink RRC messages, and/or sidelink MAC-CE. In some examples, the UEs 1202a . . . 1202N of the network coding group may further select a pattern for network coded sidelink transmissions. For example, the pattern may be selected dynamically for a sequence of sidelink transmissions between the UEs 1202a . . . 1202N in the network coding group.

At 1208a and 1208N, two or more of the UEs (e.g., UE1 1202a and UEN 1202N) may select respective resources for a network coded sidelink transmission. Each of the UEs (e.g., at least UE1 1202a and UEN 1202N) may select resources for the network coded sidelink transmission in response to two or more initial sidelink transmissions being transmitted within the network coding group. In some examples, each of the UEs (e.g., at least UE1 1202a and UEN 1202N) may select resources for the network coded sidelink transmission based on respective feedback (e.g., ACK/NACK) received for each of the initial sidelink transmissions. In some examples, upon selecting the respective resource, each of the UEs 1202a and 1202N may transmit a sidelink reservation message reserving the resource for a network coded sidelink transmission. In other examples, the UEs 1202a and 1202N may have previously reserved the respective resource (e.g., as described in FIGS. 6A and 6B), and as such, may select the previously reserved resource for the network coded sidelink transmission. For example, the previously reserved resource may originally have been for a different sidelink transmission or for a retransmission of one of the initial sidelink transmissions.

At 1210, UE1 1202a may transmit the network coded sidelink transmission on the resource selected by UE1 1202a for the network coded sidelink transmission. In some examples, the resource is an earlier resource of the respective resources selected for the network coded sidelink transmission by at least UE1 1202a and UEN 1202N. Thus, the resource selected by UE1 1202a may be the earliest resource selected for the network coded transmission by any of the UEs 1202a . . . 1202N.

At 1212, UEN 1202N may optionally transmit the network coded sidelink transmission on the resource selected by UEN 1202N for the network coded sidelink transmission. In some examples, the UEN 1202N may implicitly or explicitly release the resource selected by UEN 1202N upon receiving the network coded sidelink transmission on the resource selected by UE1 or a sidelink reservation for the network coded sidelink transmission from the UE1 1202a. For example, the UEN 1202N may implicitly release the selected resource by not using the selected resource for a sidelink transmission. As another example, the UEN 1202N may explicitly release the selected resource by transmitting a sidelink message indicating the UEN 1202N is releasing the selected resource. By explicitly releasing the selected resource, the resource reserved by UEN for the network coded sidelink transmission may be used by other UEs for sidelink communication.

In other examples, both resources are used to transmit the network coded sidelink transmission. In this example, both UE1 1202a and UEN 1202N transmit respective network coded sidelink transmissions including the same TBs at 1210 and 1212 using their respective selected resources. In some examples, the UEs 1202a . . . 1202N within the network coding group may select between using the earlier resource or all of the selected resources for the network coded sidelink transmission based on pre-configuration or a priority of the transport block(s).

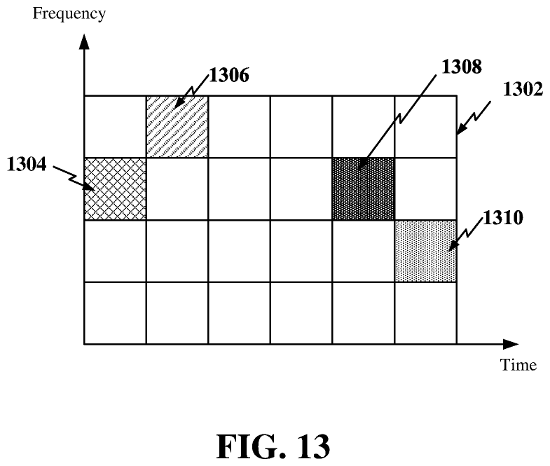

FIG. 13 is a diagram illustrating an example of resources selected for a network coded sidelink transmission according to some aspects. In the example shown in FIG. 13, a plurality of resources 1302 are illustrated, with time along the horizontal access and frequency along the vertical access. Each resource 1302 may correspond, for example, to one or more sub-channels in the frequency domain and one slot in the time domain.

Within a network coding group that is communicating using Mode 2 sidelink, the wireless communication devices (e.g., UEs) may select resources for a network coded sidelink transmission. As shown in FIG. 13, four UEs within a network coding group may each select a respective resource 1304, 1306, 1308, and 1310 for the network coded sidelink transmission. For example, a first UE (UE1) may select resource 1304, a second UE (UE2) may select resource 1306, a third UE (UE3) may select resource 1308, and a fourth UE (UE4) may select resource 1310. In some examples, the earlier in time resource (e.g., resource 1304) may be used for the network coded sidelink transmission, while the remainder of the resources 1306, 1308, and 1310 may be implicitly or explicitly released. In other examples, all of the resources 1304, 1306, 1308, and 1310 may be used, each for a respective network coded sidelink transmission.

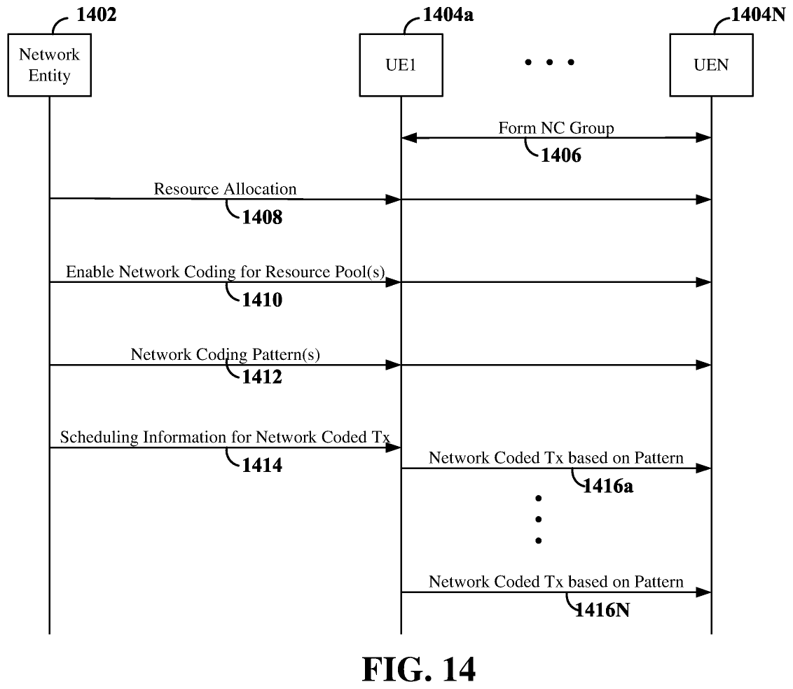

FIG. 14 is a signaling diagram illustrating other exemplary signaling between a network entity 1402 and wireless communication devices (e.g., UE1 1404a UEN 1404N) for sidelink network coding according to some aspects. Each of the UEs 1404a . . . 1404N may correspond to any of the UEs, sidelink devices, V2X devices, D2D devices, or other scheduled entities illustrated in any of FIGS. 1, 2, and/or 7-11. The network entity 1404 may be implemented as an aggregated base station or a disaggregated base station. In a disaggregated base station architecture, the network entity 1404 may include one or more of a central unit (CU), a distributed unit (DU), or a radio unit (RU). In addition, each of the UEs 1404a . . . 1404N may communicate using Mode 1 sidelink communication, in which the network entity 1402 may allocate resources to the wireless communication devices (e.g., UEs 1404a . . . 1404N) for sidelink communication between the wireless communication devices.

At 1406, the UEs 1404a . . . 1404N may exchange sidelink messages to form a network coding (NC) group. The sidelink messages may be exchanged, for example, using resources allocated by the network entity 1402 (e.g., based on scheduling request(s) received by the network entity 1402 from one or more of the UEs 1404a . . . 1404N requesting resources for forming the NC group or using a configured grant from the network entity 1402). The sidelink messages may indicate, for example, a respective capability of each of the UEs 1404a . . . 1404N to support sidelink network coding. At 1406, the UEs 1404a . . . 1404N may form a network coding group based on the respective capabilities of each of the UEs 1404a . . . 1404N.

At 1408, the network entity 1402 may provide a resource allocation of a plurality of resources dedicated for network coded sidelink transmissions to the UEs 1404a . . . 1404N. In some examples, the network entity 1402 may provide the resource allocation prior to the UEs 1404a . . . 1404N forming the NC group. The resources may be grant-based or grant-free (e.g., shared) resources (e.g., via a configured grant). For example, the plurality of resources may include one or more resource pools. In some examples, the resource pools dedicated for network coding may include all configured sidelink resource pools or a subset of the configured sidelink resource pools. In some examples, the resource pools dedicated for network coding may be used for other types of sidelink communication (e.g., other than network coding) or may be exclusively used for network coding.

At 1410, the network entity 1402 may further optionally provide an indication enabling (activating) a network coding feature for the resource pool(s). For example, the network entity 1402 may provide an indication enabling (activating) the network coding feature for each of the resource pools. In other examples, the network entity 1402 may enable (activate) the network coding feature for a subset of the resource pools. In some examples, the network entity 1402 may enable (activate) the network coding feature for each of the resource pools or for a subset of the resource pools for a duration or may enable (activate) the network coding feature for each of the resource pools or for a subset of the resource pools until a disable (deactivation) indication is provided. For example, the NC resource allocation may be sent via a radio resource control (RRC) message, while the indication enabling the network coding feature may be sent via a medium access control (MAC) control element (MAC-CE) or via DCI.

At 1412, the network entity 1402 may further configure one or more patterns for network coded sidelink transmissions and provide the network coding pattern(s) to the UEs 1404a . . . 1404N. In some examples, the network entity 1402 may configure one or more respective network coding patterns for each of the one or more resource pools. In other examples, the network entity 1402 may configure one or more patterns applicable to all of the resource pools configured for network coding. In some examples, the NC resource allocation may include the NC pattern(s) configured for the NC resource allocation (e.g., per resource pool or all resource pools). In other examples, the NC pattern(s) may be provided separate from the NC resource allocation. For example, the NC resource allocation may be provided within an RRC message, and the NC pattern(s) for one or more resource pools may be provided within a MAC-CE or DCI.

Each pattern indicates a sequence of sidelink transmissions, which may include the initial sidelink transmissions and one or more network coded sidelink transmissions, where each of the network coded sidelink transmissions uses a respective network encoding function (e.g., Erasure encoding such as a single parity check code or a MDS code, or other suitable encoding). In some examples, there may be n possible sidelink transmissions for a particular number of erasures, and the network entity may select k out of the n possible sidelink transmissions for a pattern. For example, a pattern with two erasures may include: [a, b, c, a+b+c, a+a b+a²·c], where a, b, and c are each respective transport blocks (TBs). In this example, a receiving UE may be able to correctly decode all three TBs (a, b, and c) by successfully decoding three out of the five sidelink transmissions in the pattern. Other examples of patterns of sidelink transmissions of TBs for a single erasure may include:

TB1 TB2 TB3 TB1 + TB2 + TB3
TB1 TB1 TB2 TB1 + TB2
TB1 TB2 TB1 + TB2
TB1 TB2 TB1 + TBx, where TBx is for another UE

Each of the TBs may be sent by (originated/initiated by) the same UE (e.g., UE 1404a), as shown in the first three examples above, or a combination of different UEs (e.g., UE 1404a . . . 1404N), as shown in the last example above including TBx, within the network coding group. Moreover, a pattern may include repetition of TBs (e.g., TB1, TB1 shown above) based on the sidelink channel quality, priority of the TBs, and/or other suitable factors.

At 1414, the network entity 1402 may optionally provide scheduling information for a network coded sidelink transmission to a wireless communication device (e.g., UE 1404a). For example, the network entity 1402 may provide DCI including the scheduling information. In some examples, the scheduling information schedules respective resources for the initial sidelink transmission(s) and the network coded sidelink transmission(s) within a resource pool configured for network coding, and further indicates a corresponding pattern for network coding. In other examples, the scheduling information schedules respective resources for the initial transmission(s) and one or more retransmissions that may be used for network coded sidelink transmissions upon receiving a NACK for one or more of the initial transmissions. In this example, the scheduling information may further indicate the pattern to be used for network coding. In other examples, the UE 1404a may select a pattern from available patterns configured for the resource pool including the resource over which the network coded sidelink transmission is scheduled. For example, the network entity 1402 may schedule the resource for the network coded sidelink transmission, and the UE 1404a may select the pattern from the configured patterns for the resource pool containing the scheduled resource. In still other examples, the UE 1404a may select a resource from previous configured resources (e.g., grant-free or shared resources) and may further select a pattern autonomously or from previously configured patterns for the resource pool containing the selected resource.

In still other examples, the network entity 1402 may schedule the resource(s) for the network coded sidelink transmission(s) separately from the initial sidelink transmission(s). In this example, the network entity 1402 may schedule the resource(s) for the initial sidelink transmission(s) for other UEs (e.g., UEN 1404N) and may schedule the resource(s) for the network coded sidelink transmission(s) for the UE 1404a or may schedule respective resource(s) for the network coded sidelink transmission(s) for multiple UEs (e.g., UE 1404a and UE 1404N).

At 1416a . . . 1416N, the UE 1404a may transmit one or more network coded sidelink transmissions based on the selected pattern. In some examples, the UE 1404a may transmit the network coded sidelink transmission(s) after transmitting one or more initial sidelink transmissions including transport blocks within the network coded sidelink transmission.

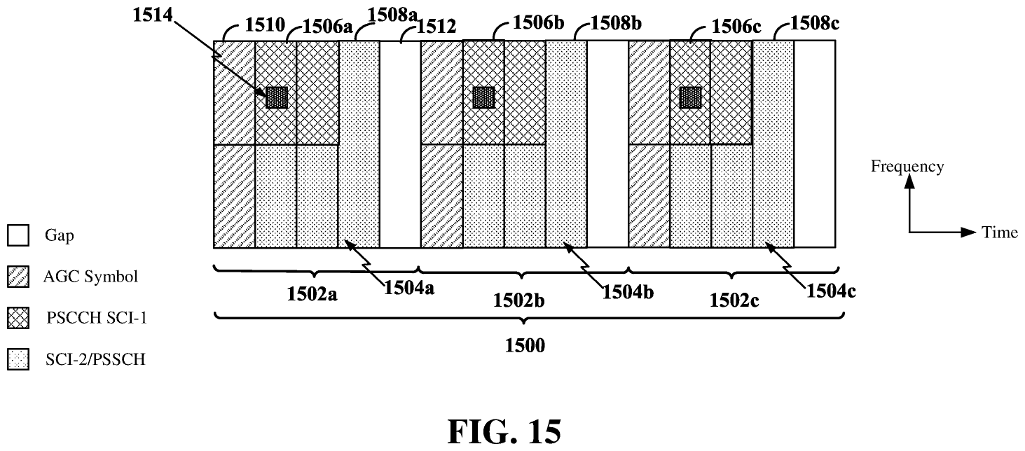

FIG. 15 is a diagram illustrating an example of a slot 1500 used for network coding according to some aspects. In the example shown in FIG. 15, time is in the horizontal direction with units of symbols (e.g., OFDM symbols); and frequency is in the vertical direction. In the example shown in FIG. 15, the slot 1500 is divided into a plurality of mini-slots 1502a, 1502b, and 1502c. Each mini-slot 1502a, 1502b, 1502c includes four symbols.

Each mini-slot 1502a, 1502b, and 1502c further includes a respective PSCCH 1506a, 1506b, and 1506c and a PSSCH 1508a, 1508b, and 1508c. The PSCCH 1506 includes, for example, SCI-1 that schedules transmission of data traffic on time-frequency resources of the corresponding PSSCH 1508a, 1508b, and 1508c. As shown in FIG. 15, the starting symbol for each of the PSCCHs 1506a, 1506b, and 1506c is the second symbol of the corresponding mini-slot 1502a, 1502b, and 1502c, and each PSCCH 1506a, 1506b, and 1506c spans two symbols. Each of the respective PSSCHs 1508a, 1508b, and 1508c may be time-division multiplexed (TDMed) with the corresponding PSCCH 1506a, 1506b, and 1506c and/or frequency-division multiplexed (FDMed) with the corresponding PSCCH 1506a, 1506b, and 1506c for the respective mini-slot 1502a, 1502b, and 1502c. In addition, each of the PSSCHs 1508a, 1508b, and 1508c may include respective SCI-2. A respective gap symbol 1512 is present after each PSSCH 1508a, 1508b, and 1508 in the mini-slots 1502a, 1502b, and 1502c. In addition, as shown in FIG. 15, the second symbol of each mini-slot 1502a, 1502b, and 1502c is copied onto (repeated on) a first symbol 1510 thereof for automatic gain control (AGC) settling.

In addition, the PSSCHs 1508a, 1508b, and 1508c may each include transport block(s) 1504a, 1504b, and 1504c, which may correspond to a single transport block of an initial sidelink transmission, a retransmission thereof or to multiple transport blocks of a network coded sidelink transmission. In some examples, the PSCCH/SCI-1 1506a, 1506b, and 1506c of each of the mini-slots 1502a, 1502b, and 1502c may include a sidelink transmission (SL Tx) type field 1514 indicating whether the sidelink transmission carried within the mini-slot 1502a, 1502b, and 1502c is a regular sidelink transmission (e.g., an initial sidelink transmission or retransmission) of a single transport block or a network coded sidelink transmission of multiple transport blocks.

In some examples, the PSSCHs 1508a, 1508b, and 1508c may be used to transmit the transport block(s) based on a selected or configured pattern. For example, for a pattern of [TB1, TB2, TB1+TB2], the first mini-slot 1502a may be used to transmit TB1 1504a, the second mini-slot 1502b may be used to transmit TB2 1504b, and the third mini-slot 1502c may be used to transmit TB1+TB2 (e.g., a network coded sidelink transmission) 1504c.

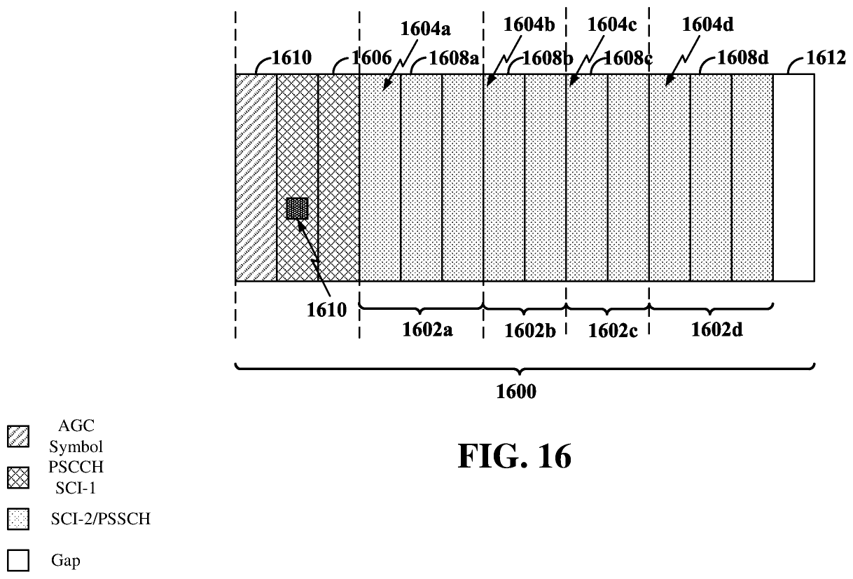

FIG. 16 is a diagram illustrating an example of a slot 1600 used for network coding according to some aspects. In the example shown in FIG. 16, time is in the horizontal direction with units of symbols (e.g., OFDM symbols); and frequency is in the vertical direction. In the example shown in FIG. 16, the slot 1600 is divided into a plurality of subslots 1602a, 1602b, 1602c, and 1602d. Each subslot 1602a, 1602b, 1602c, and 1602d includes a variable number of symbols within slot 1600. In some examples, the number of symbols may be determined based on a pattern (sequence) of network coding.

The slot 1600 further includes a PSCCH 1606 including, for example, SCI-1 that schedules transmission of data traffic on time-frequency resources for a number of subslots 1602a, 1602b, 1602c, and 1602d within the same slot 1600 or future slot(s). Each subslot 1602a, 1602b, 1602c, and 1602d carries a respective PSSCH 1608a, 1608b, 1608c, and 1608d. As shown in FIG. 16, the starting symbol for the PSCCH 1606 is the second symbol of the slot 1600 and spans two symbols. Each of the respective PSSCHs 1608a, 1608b, 1608c, and 1608d may be time-division multiplexed (TDMed) with the corresponding PSCCH 1606. In addition, each of the PSSCHs 1608a, 1608b, 1608c, and 1608d may include respective SCI-2. A gap symbol 1612 is present at the end of the slot 1600. In the example shown in FIG. 16, gap symbols are not present between subslots since there is no Tx/Rx switching between the subslots 1602a, 1602b, 1602c, and 1602d. In addition, as shown in FIG. 16, the second symbol of the slot 1602 is copied onto (repeated on) a first symbol 1610 thereof for automatic gain control (AGC) settling. AGC symbols may not be needed for each subslot 1602a, 1602b, 1602c, and 1602d since the receiver can set the AGC based on the first symbol 1610 of the slot 1600 and use the same setting for reception for the respective PSSCHs 1608a, 1608b, 1608c, and 1608d of any of the subslots 1602a, 1602b, 1602c, and 1602d.

In addition, the PSSCHs 1608a, 1608b, 1608c, and 1608d may each include transport block(s) 1604a, 1604b, 1604c, and 1604d which may correspond to a single transport block of an initial sidelink transmission, a retransmission thereof or to multiple transport blocks of a network coded sidelink transmission. In some examples, the PSCCH/SCI-1 1606 may include a sidelink transmission (SL Tx) type field 1610 indicating the respective transmission type (e.g., regular sidelink transmission or a network coded sidelink transmission) of each of the subslots 1602a, 1602b, 1602c, and 1602d.

In some examples, the PSSCHs 1608a, 1608b, 1608c, and 1608d may be used to transmit the transport block(s) based on a selected or configured pattern. For example, for a pattern of [TB1, TB2, TB3, TB1+TB2+TB3], the first subslot 1602a may be used to transmit TB1 1604a, the second subslot 1602b may be used to transmit TB2 1604b, the third subslot 1602c may be used to transmit TB3 1604c, and the fourth subslot 1602d may be used to transmit TB1+TB2+TB3 (e.g., a network coded sidelink transmission) 1604d.

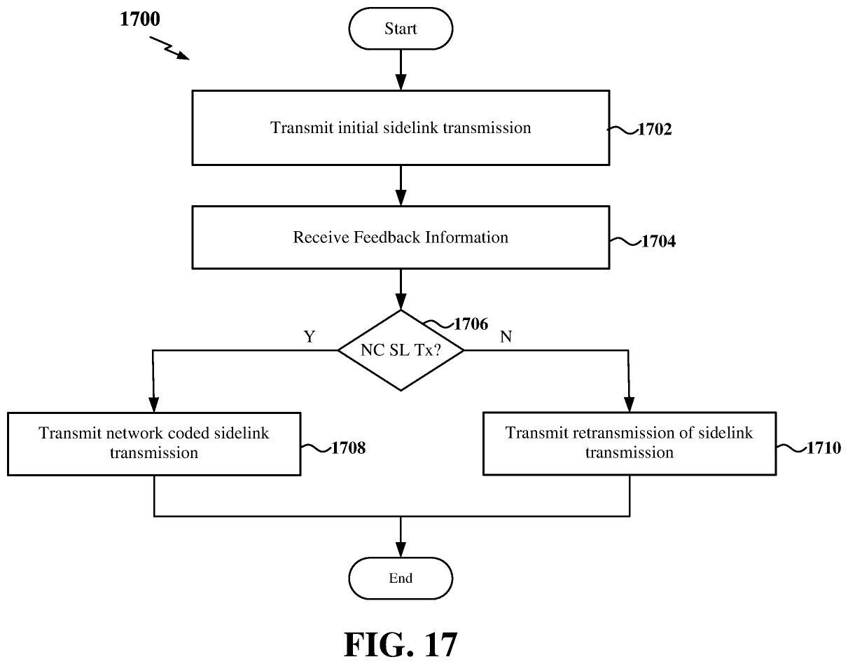

FIG. 17 is a flowchart illustrating process 1700 for selective network coding according to some aspects. As described below, some or all illustrated features may be omitted in a particular implementation within the scope of the present disclosure, and some illustrated features may not be required for implementation of all examples. In some examples, the method may be performed by the wireless communication device 1800, as described below and illustrated in FIG. 17, by a processor or processing system, or by any suitable means for carrying out the described functions.

At block 1702, the wireless communication device (e.g., a transmitting wireless communication device) may transmit an initial sidelink transmission of a transport block to one or more receiving wireless communication devices within a network coding group. At block 1704, the transmitting wireless communication device may receive feedback information (e.g., HARQ ACK/NACK) from the receiving wireless communication device(s).

At block 1706, the transmitting wireless communication device may decide whether to send a retransmission of the transport block or a network coded sidelink transmission including the transport block and one or more other transport blocks from other initial sidelink transmissions transmitted by the transmitting wireless communication device or other wireless communication devices within the network coding group based on, for example, receiving a NACK for the initial sidelink transmission. In some examples, the transmitting wireless communication device may decide whether to send the retransmission or the network coded sidelink transmission based on at least one of a quality of a sidelink channel, a priority of the first sidelink transmission, a quality of service (QoS) of the first sidelink transmission, a remaining packet delay budget of the first sidelink transmission, or a fixed number of retransmissions (e.g., here, the transmitting wireless communication device may decide to transmit the network coded sidelink transmission prior to reaching the fixed/maximum number of retransmissions).

In other examples, the transmitting wireless communication device may decide to transmit the network coded sidelink transmission based on a probability of transmitting the network coded sidelink transmission instead of the retransmission. For example, the probability may be based on at least one of a quality of a sidelink channel, a respective priority of at least one of the initial sidelink transmissions, a respective quality of service (QoS) of at least one of the initial sidelink transmissions, or a respective remaining packet delay budget of each of the initial sidelink transmission. In some examples, the probability may be optimized based on respective probabilities shared from other wireless communication devices directly or through the network (e.g., via a network entity).

If the transmitting wireless communication device decides to transmit a network coded sidelink transmission (Y branch of block 1706), at block 1708, the transmitting wireless communication device may generate and transmit the network coded sidelink transmission to one or more receiving wireless communication devices within the network coding group. However, if the transmitting wireless communication device decides to transmit a retransmission of the transport block (N branch of block 1706), at block 1710, the transmitting wireless communication device may transmit the retransmission of the transport block.

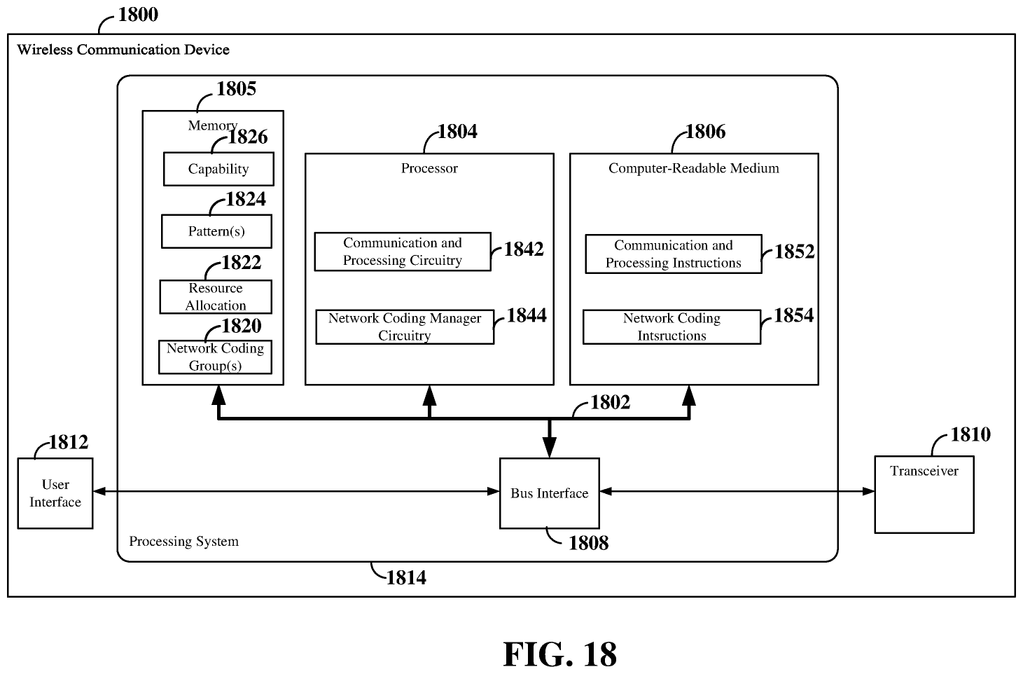

FIG. 18 is a block diagram illustrating an example of a hardware implementation for a wireless communication device 1800 employing a processing system 1814. For example, the wireless communication device 1800 may correspond to a sidelink device (e.g., a V2X device or D2D device), a UE or other scheduled entity, as shown and described above in reference to FIGS. 1, 2, 7-12, and/or 14.

The wireless communication device 1800 may be implemented with a processing system 1814 that includes one or more processors 1804. Examples of processors 1804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1800 may be configured to perform any one or more of the functions described herein. That is, the processor 1804, as utilized in the wireless communication device 1800, may be used to implement any one or more of the processes and procedures described below.

In this example, the processing system 1814 may be implemented with a bus architecture, represented generally by the bus 1802. The bus 1802 may include any number of interconnecting buses and bridges depending on the specific application of the processing system 1814 and the overall design constraints. The bus 1802 links together various circuits including one or more processors (represented generally by the processor 1804), a memory 1805, and computer-readable media (represented generally by the computer-readable medium 1806). The bus 1802 may also link various other circuits such as timing sources, peripherals, voltage regulators, and power management circuits, which are well known in the art, and therefore, will not be described any further.

A bus interface 1808 provides an interface between the bus 1802 and a transceiver 1810. The transceiver 1810 provides a means for communicating with various other apparatus over a transmission medium (e.g., air interface). Depending upon the nature of the apparatus, a user interface 1812 (e.g., keypad, display, touch screen, speaker, microphone, control knobs, etc.) may also be provided. Of course, such a user interface 1812 is optional, and may be omitted in some examples.

The processor 1804 is responsible for managing the bus 1802 and general processing, including the execution of software stored on the computer-readable medium 1806. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1804, causes the processing system 1814 to perform the various functions described below for any particular apparatus. The computer-readable medium 1806 and the memory 1805 may also be used for storing data that is manipulated by the processor 1804 when executing software. For example, the memory 1805 may store one or more of a network coding group 1820 (e.g., UEIDs of each of the members of the network coding group), a resource allocation 1822 of dedicated resources for network coding, one or more patterns 1824 for network coding, and/or a capability 1826 of the wireless communication device 1800 to support network coding which may be used by the processor 1804 in generating and processing network coded sidelink transmissions.

The computer-readable medium 1806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1806 may reside in the processing system 1814, external to the processing system 1814, or distributed across multiple entities including the processing system 1814. The computer-readable medium 1806 may be embodied in a computer program product. By way of example, a computer program product may include a computer-readable medium in packaging materials. In some examples, the computer-readable medium 1806 may be part of the memory 1805. Those skilled in the art will recognize how best to implement the described functionality presented throughout this disclosure depending on the particular application and the overall design constraints imposed on the overall system.

In some aspects of the disclosure, the processor 1804 may include circuitry configured for various functions. For example, the processor 1804 may include communication and processing circuitry 1842, configured to communicate with a network entity (e.g., an aggregated or disaggregated base station) via a cellular (e.g., Uu) interface and one or more other wireless communication devices via a sidelink (e.g., PC5) interface. In some examples, the communication and processing circuitry 1842 may include one or more hardware components that provide the physical structure that performs processes related to wireless communication (e.g., signal reception and/or signal transmission) and signal processing (e.g., processing a received signal and/or processing a signal for transmission).

In some implementations where the communication involves receiving information, the communication and processing circuitry 1842 may obtain information from a component of the wireless communication device 1800 (e.g., from the transceiver 1810 that receives the information via radio frequency signaling or some other type of signaling suitable for the applicable communication medium), process (e.g., decode) the information, and output the processed information. For example, the communication and processing circuitry 1842 may output the information to another component of the processor 1804, to the memory 1805, or to the bus interface 1808. In some examples, the communication and processing circuitry 1842 may receive one or more of signals, messages, other information, or any combination thereof. In some examples, the communication and processing circuitry 1842 may receive information via one or more channels. In some examples, the communication and processing circuitry 1842 may include functionality for a means for receiving. In some examples, the communication and processing circuitry 1842 may include functionality for a means for processing, including a means for demodulating, a means for decoding, etc.

In some implementations where the communication involves sending (e.g., transmitting) information, the communication and processing circuitry 1842 may obtain information (e.g., from another component of the processor 1804, the memory 1805, or the bus interface 1808), process (e.g., modulate, encode, etc.) the information, and output the processed information. For example, the communication and processing circuitry 1842 may output the information to the transceiver 1810 (e.g., that transmits the information via radio frequency signaling or some other type of signaling suitable for the applicable communication medium). In some examples, the communication and processing circuitry 1842 may send one or more of signals, messages, other information, or any combination thereof. In some examples, the communication and processing circuitry 1842 may send information via one or more channels. In some examples, the communication and processing circuitry 1842 may include functionality for a means for sending (e.g., a means for transmitting). In some examples, the communication and processing circuitry 1842 may include functionality for a means for generating, including a means for modulating, a means for encoding, etc.

In examples in which the wireless communication device is a transmitting wireless communication device (e.g., a first wireless communication device), the communication and processing circuitry 1842 may be configured to exchange (via the transceiver 1810) one or more sidelink messages with a second wireless communication device to form a network coding group 1820 including at least the first wireless communication device and the second wireless communication device based on a respective capability 1826 of each of the first wireless communication device and the second wireless communication device to support sidelink network coding. The communication and processing circuitry 1842 may further be configured to transmit a network coded sidelink transmission including transport blocks associated with at least a first sidelink transmission and a second sidelink transmission to at least the second wireless communication device. In this example, the second wireless communication device may be an intended recipient of at least one of the first sidelink transmission or the second sidelink transmission.

In some examples, the communication and processing circuitry 1842 may be configured to receive the second sidelink transmission from a third wireless communication device. In this example, the second sidelink transmission may be destined for at least a fourth wireless communication device, and the network coding group may further include at least the third wireless communication device and the fourth wireless communication device. In some examples, the communication and processing circuitry 1842 may be configured to listen to a sidelink channel for the second sidelink transmission initiated by the third wireless communication device and destined for at least the fourth wireless communication device.

In some examples, the communication and processing circuitry 1842 may further be configured to receive respective feedback for each of the first sidelink transmission and the second sidelink transmission. In addition, the communication and processing circuitry 1842 may be configured to transmit the network coded sidelink transmission in response to the respective feedback.

The communication and processing circuitry 1842 may further be configured to receive a resource allocation 1822 of a plurality of resources dedicated for network coded sidelink transmissions from a network entity. The communication and processing circuitry 1842 may further be configured to transmit the network coded sidelink transmission over a resource of the plurality of resources. In some examples, the communication and processing circuitry 1842 may be configured to receive an indication from the network entity enabling a network coding feature for each of the one or more resource pools. In some examples, the communication and processing circuitry 1842 may further be configured to transmit the network coded sidelink transmission as part of a pattern 1824 for network coded sidelink transmissions for a resource pool of the one or more resource pools including the resource. The pattern 1824 includes a sequence of sidelink transmissions including the network coded sidelink transmission.

In examples in which the wireless communication device is a receiving wireless communication device (e.g., a second wireless communication device), the communication and processing circuitry 1842 may be configured to exchange one or more sidelink messages with a first wireless communication device to form a network coding group 1820 including at least the first wireless communication device and the second wireless communication device based on a respective capability 1826 of each of the first wireless communication device and the second wireless communication device to support sidelink network coding. The communication and processing circuitry 1842 may further be configured to receive a network coded sidelink transmission including at least a first sidelink transmission and a second sidelink transmission from the first wireless communication device. Here, the second wireless communication device may be an intended recipient of at least one of the first sidelink transmission or the second sidelink transmission.

The communication and processing circuitry 1842 may further be configured to receive a resource allocation 1822 of a plurality of resources dedicated for network coded sidelink transmissions from a network entity. The communication and processing circuitry 1842 may further be configured to receive the network coded sidelink transmission over a resource of the plurality of resources. The communication and processing circuitry 1842 may further be configured to receive the network coded sidelink transmission as part of a pattern 1824 for network coded sidelink transmissions for a resource pool including the resource. The pattern 1824 includes a sequence of sidelink transmissions including the network coded sidelink transmission. In some examples, the communication and processing circuitry 1842 may be configured to receive the network coded sidelink transmission on a first resource. The first resource may be an earlier resource of at least two resources selected for the network coded sidelink transmission by members of the network coding group or one of the at least two resources that are each used for a respective network coded sidelink transmission. The communication and processing circuitry 1842 may further be configured to execute communication and processing instructions (software) 1852 stored in the computer-readable medium 1806 to implement one or more of the functions described herein.

The processor 1804 may further include network coding manager circuitry 1844, configured to form the network coding group 1820 based on the respective capabilities 1826 of each of the members of the network coding group. In some examples, the respective capability 1826 of each of the first wireless communication device and the second wireless communication device is a dynamic capability based on an energy status thereof.

In addition, the network coding manager circuitry 1844 may further be configured to operate together with the communication and processing circuitry 1842 to transmit the network coded sidelink transmission based on a probability of transmitting the network coded sidelink transmission instead of respective individual retransmissions of the first sidelink transmission and the second sidelink transmission. The probability may be based on at least one of a quality of a sidelink channel, a respective priority of at least one of the first sidelink transmission or the second sidelink transmission, a respective quality of service (QoS) of at least one of the first sidelink transmission or the second sidelink transmission, or a respective remaining packet delay budget of each of the first sidelink transmission and the second sidelink transmission.

In some examples, the network coding manager circuitry 1844 may further be configured to decide whether to send a retransmission of a transport block of the first sidelink transmission or the network coded transmission based on at least one of a quality of a sidelink channel, a priority of the first sidelink transmission, a quality of service (QoS) of the first sidelink transmission, a remaining packet delay budget of the first sidelink transmission, or a fixed number of retransmissions. In some examples, the network coding manager circuitry 1844 may be configured to operate together with the communication and processing circuitry 1842 to transmit the network coded sidelink transmission including sidelink control information including a sidelink transmission type field indicating a network coded sidelink transmission type.

In some examples, the network coding manager circuitry 1844 may be configured to operate together with the communication and processing circuitry 1842 to transmit the network coded sidelink transmission as part of the pattern 1824 for network coded sidelink transmissions for a resource pool of the one or more resource pools including the resource (e.g., a scheduled resource or a selected resource) on which the network coded sidelink transmission is transmitted. In some examples, the network coding manager circuitry 1844 may be configured to select the pattern from a plurality of patterns (e.g., two or more patterns) configured for the resource pool.

In some examples, the network coding manager circuitry 1844 may further be configured to select a first resource for the network coded sidelink transmission. The first resource may be an earlier resource of at least two resources selected for the network coded sidelink transmission by members of the network coding group or one of the at least two resources that are each used for a respective network coded sidelink transmission.

In some examples, the network coding manager circuitry 1844 may correspond to any of the network coding (NC) manager(s) of wireless communication devices shown in FIGS. 1 and/or 2. The network coding manager circuitry 1844 may further be configured to execute NC manager instructions (software) 1854 stored in the computer-readable medium 1806 to implement one or more of the functions described herein.

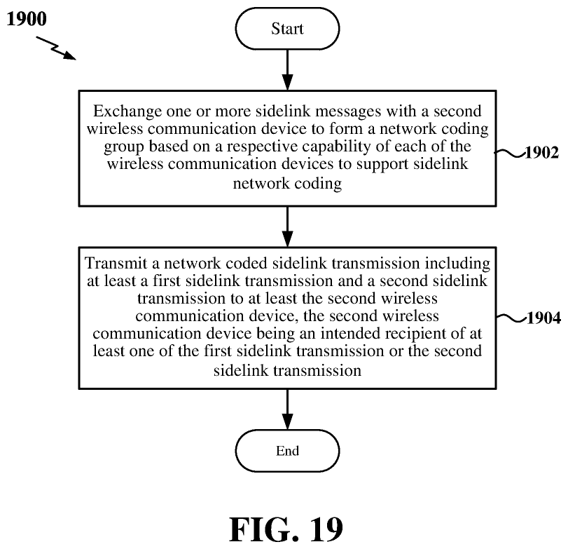

FIG. 19 is a flow chart of an exemplary process 1900 for network coded sidelink transmissions within a network coding group according to some aspects. As described below, some or all illustrated features may be omitted in a particular implementation within the scope of the present disclosure, and some illustrated features may not be required for implementation of all examples. In some examples, the method may be performed by the wireless communication device 1800, as described above and illustrated in FIG. 18, by a processor or processing system, or by any suitable means for carrying out the described functions.

At block 1902, the wireless communication device (e.g., a first wireless communication device) may exchange one or more sidelink messages with a second wireless communication device to form a network coding group including at least the first wireless communication device and the second wireless communication device based on a respective capability of each of the first wireless communication device and the second wireless communication device to support sidelink network coding. In some examples, the respective capability of each of the first wireless communication device and the second wireless communication device is a dynamic capability based on an energy status thereof. For example, the communication and processing circuitry 1842, together with the network coding manager circuitry 1844 and transceiver 1810, shown and described above in connection with FIG. 18, may provide a means to exchange the sidelink messages.

At 1904, the first wireless communication device may transmit a network coded sidelink transmission including transport blocks associated with at least a first sidelink transmission and a second sidelink transmission to at least the second wireless communication device, the second wireless communication device being an intended recipient of at least one of the first sidelink transmission or the second sidelink transmission. In some examples, the second wireless communication device is the intended recipient of the first sidelink transmission and the first sidelink transmission is initiated by the first wireless communication device or another wireless communication device. In this example, the first wireless communication device may be configured to receive the second sidelink transmission from a third wireless communication device, where the second sidelink transmission is destined for at least a fourth wireless communication device. The network coding group further includes at least the third wireless communication device and the fourth wireless communication device. In some examples, the first wireless communication device may further listen to a sidelink channel for the second sidelink transmission initiated by the third wireless communication device and destined for at least the fourth wireless communication device.

In some examples, the first wireless communication device may receive respective feedback for each of the first sidelink transmission and the second sidelink transmission. In addition, the first wireless communication device may transmit the network coded sidelink transmission in response to the respective feedback.

In some examples, the first wireless communication device may transmit the network coded sidelink transmission based on a probability of transmitting the network coded sidelink transmission instead of respective individual retransmissions of the first sidelink transmission and the second sidelink transmission. The probability may be based on at least one of a quality of a sidelink channel, a respective priority of at least one of the first sidelink transmission or the second sidelink transmission, a respective quality of service (QoS) of at least one of the first sidelink transmission or the second sidelink transmission, or a respective remaining packet delay budget of each of the first sidelink transmission and the second sidelink transmission.

In some examples, the first sidelink transmission is initiated by the first wireless communication device. In this example, the first wireless communication device may decide whether to send a retransmission of a transport block of the first sidelink transmission or the network coded transmission based on at least one of a quality of a sidelink channel, a priority of the first sidelink transmission, a quality of service (QoS) of the first sidelink transmission, a remaining packet delay budget of the first sidelink transmission, or a fixed number of retransmissions. In some examples, the network coded sidelink transmission includes sidelink control information including a sidelink transmission type field indicating a network coded sidelink transmission type.

In some examples, the first wireless communication device may receive a resource allocation of a plurality of resources dedicated for network coded sidelink transmissions from a network entity. The first wireless communication device may further transmit the network coded sidelink transmission over a resource of the plurality of resources. In this example, the plurality of resources can include one or more resource pools of a plurality of resource pools. The first wireless communication device may further receive an indication from the network entity, in which the indication enables a network coding feature for each of the one or more resource pools.

The first wireless communication device may further transmit the network coded sidelink transmission as part of a pattern for network coded sidelink transmissions for a resource pool of the one or more resource pools including the resource. The pattern includes a sequence of sidelink transmissions comprising the network coded sidelink transmission. The first wireless communication device may further select the pattern from a plurality of patterns configured for the resource pool.

In some examples, the first wireless communication device may select a first resource for the network coded sidelink transmission. The first resource may be an earlier resource of at least two resources selected for the network coded sidelink transmission by members of the network coding group or one of the at least two resources that are each used for a respective network coded sidelink transmission. For example, the communication and processing circuitry 1842, together with the network coding manager circuitry 1844 and transceiver 1810, shown and described above in connection with FIG. 18 may provide a means to transmit the network coded sidelink transmission.

In one configuration, the wireless communication device 1800 (e.g., first wireless communication device) includes means for exchanging one or more sidelink messages with a second wireless communication device to form a network coding group comprising at least the first wireless communication device and the second wireless communication device based on a respective capability of each of the first wireless communication device and the second wireless communication device to support sidelink network coding. In addition, the wireless communication device 1800 includes means for transmitting a network coded sidelink transmission comprising transport blocks associated with at least a first sidelink transmission and a second sidelink transmission to at least the second wireless communication device, the second wireless communication device being an intended recipient of at least one of the first sidelink transmission or the second sidelink transmission. In one aspect, the aforementioned means may be the processor 1804 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1, 2, 7-12, 14, and/or 18, and utilizing, for example, the processes and/or algorithms described herein in relation to FIGS. 12, 14, 17, and/or 19.

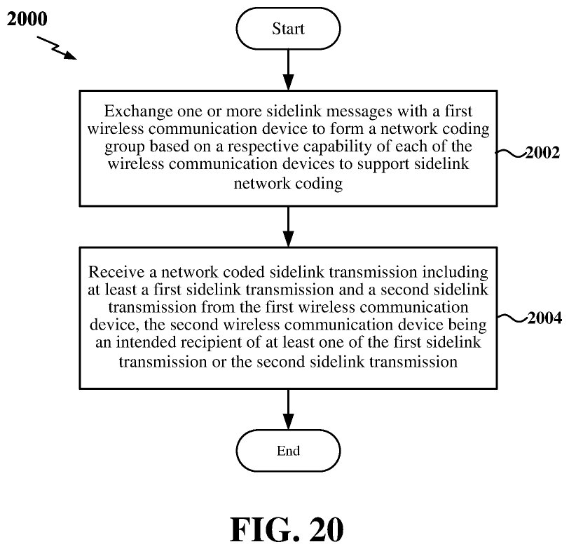

FIG. 20 is a flow chart of another exemplary process 2000 for network coded sidelink transmissions within a network coding group according to some aspects. As described below, some or all illustrated features may be omitted in a particular implementation within the scope of the present disclosure, and some illustrated features may not be required for implementation of all examples. In some examples, the method may be performed by the wireless communication device 1800, as described above and illustrated in FIG. 18, by a processor or processing system, or by any suitable means for carrying out the described functions.

At block 2002, the wireless communication device (e.g., a second wireless communication device) may exchange one or more sidelink messages with a first wireless communication device to form a network coding group including at least the first wireless communication device and the second wireless communication device based on a respective capability of each of the first wireless communication device and the second wireless communication device to support sidelink network coding. In some examples, the respective capability of each of the first wireless communication device and the second wireless communication device is a dynamic capability based on an energy status thereof. For example, the communication and processing circuitry 1842, together with the network coding manager circuitry 1844 and transceiver 1810, shown and described above in connection with FIG. 18, may provide a means to exchange the sidelink messages.

At block 2004, the second wireless communication device may receive a network coded sidelink transmission including at least a first sidelink transmission and a second sidelink transmission from the first wireless communication device, the second wireless communication device being an intended recipient of at least one of the first sidelink transmission or the second sidelink transmission. In some examples, the second wireless communication device may receive a resource allocation of a plurality of resources dedicated for network coded sidelink transmissions from a network entity. The second wireless communication device may further receive the network coded sidelink transmission over a resource of the plurality of resources. In some examples, the second wireless communication device may receive the network coded sidelink transmission as part of a pattern for network coded sidelink transmissions for a resource pool comprising the resource. The pattern includes a sequence of sidelink transmissions comprising the network coded sidelink transmission.

In some examples, the second wireless communication device may receive the network coded sidelink transmission on a first resource. The first resource may be an earlier resource of at least two resources selected for the network coded sidelink transmission by members of the network coding group or one of the at least two resources that are each used for a respective network coded sidelink transmission. For example, the communication and processing circuitry 1842, together with the network coding manager circuitry 1844 and transceiver 1810, shown and described above in connection with FIG. 18 may provide a means to receive the network coded sidelink transmission.

In one configuration, the wireless communication device 1800 (e.g., second wireless communication device) includes means for exchanging one or more sidelink messages with a first wireless communication device to form a network coding group comprising at least the first wireless communication device and the second wireless communication device based on a respective capability of each of the first wireless communication device and the second wireless communication device to support sidelink network coding. In addition, the wireless communication device 1800 includes means for receiving a network coded sidelink transmission comprising at least a first sidelink transmission and a second sidelink transmission from the first wireless communication device, the second wireless communication device being an intended recipient of at least one of the first sidelink transmission or the second sidelink transmission. In one aspect, the aforementioned means may be the processor 1804 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1, 2, 7-12, 14, and/or 18, and utilizing, for example, the processes and/or algorithms described herein in relation to FIGS. 12, 14, 17, and/or 20.

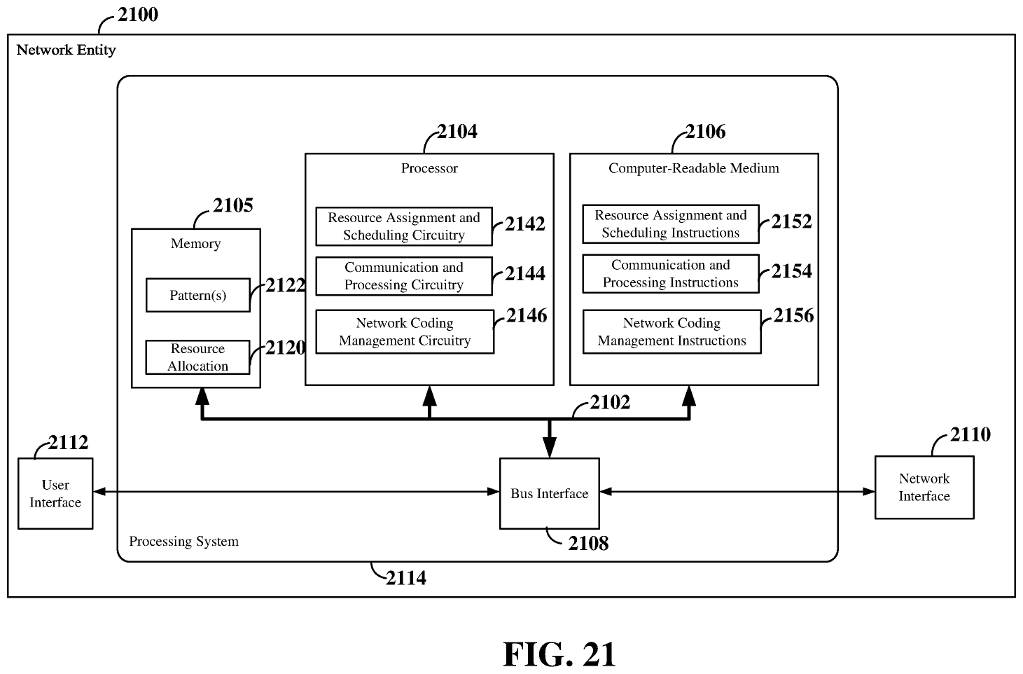

FIG. 21 is a block diagram illustrating an example of a hardware implementation for an exemplary network entity 2100 employing a processing system 2114. For example, the network entity 2100 may correspond to any of the base stations (e.g., gNBs) or other scheduling entities illustrated in any one or more of FIGS. 1, 2, and/or 14. The network entity 2100 may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC.

In accordance with various aspects of the disclosure, an element, or any portion of an element, or any combination of elements may be implemented with a processing system 2114 that includes one or more processors 2104. The processing system 2114 may be substantially the same as the processing system 1121 illustrated in FIG. 11, including a bus interface 2108, a bus 2102, memory 2105, a processor 2104, and a computer-readable medium 2106. In some examples, the memory 2105 may store one or more of a resource allocation 2120 of a plurality of resources dedicated for network coding and/or pattern(s) 2122 for network coding for use by the processor 2104 in facilitating network coding within a network coding group.

Furthermore, the network entity 2100 may include an optional user interface 2112 and a network interface 2110 substantially similar to those described above in FIG. 18. In some examples, the network interface 2110 may correspond to a transceiver. The processor 2104, as utilized in a network entity 2100, may be used to implement any one or more of the processes described below.

In some aspects of the disclosure, the processor 2104 may include circuitry configured for various functions. For example, the processor 2104 may include resource assignment and scheduling circuitry 2142, configured to generate, schedule, and modify a resource assignment or grant of time-frequency resources (e.g., a set of one or more resource elements). For example, the resource assignment and scheduling circuitry 2142 may schedule time-frequency resources within a plurality of time division duplex (TDD) and/or frequency division duplex (FDD) subframes, slots, and/or mini-slots to carry user data traffic and/or control information to and/or from multiple UEs.

In some examples, the resource assignment and scheduling circuitry 2142 may be configured to schedule resources for the transmission of a network coded sidelink transmission for Mode 1 sidelink communication. In some examples, the resource assignment and scheduling circuitry 2142 may schedule resources to provide the resource allocation 2120 to a plurality of wireless communication devices in a network coding group configured for coordinated sidelink network coding. In some examples, the resource allocation may include one or more resource pools of a plurality of resource pools. In addition, the resource assignment and scheduling circuitry 2142 may be configured to schedule resources to provide at least one respective pattern 2122 for network coded sidelink transmissions for each of the one or more resource pools. The resource assignment and scheduling circuitry 2142 may further be configured to execute resource assignment and scheduling instructions (software) 2152 stored in the computer-readable medium 2106 to implement one or more of the functions described herein.

The processor 2104 may further include communication and processing circuitry 2144, configured to communicate with the plurality of wireless communication devices in the network coding group. In some examples, the communication and processing circuitry 2144 may include one or more hardware components that provide the physical structure that performs processes related to wireless communication (e.g., signal reception and/or signal transmission) and signal processing (e.g., processing a received signal and/or processing a signal for transmission).

The communication and processing circuitry 2144 may further be configured to provide the resource allocation 2120 to the plurality of wireless communication devices in the network coding group, in which the plurality of resources includes one or more resource pools of a plurality of resource pools. In addition, the communication and processing circuitry 2144 may be configured to provide at least one respective pattern 2122 for network coded sidelink transmissions for each of the one or more resource pools. Each of the at least one respective pattern for each of the one or more resource pools includes a sequence of sidelink transmissions including one or more network coded sidelink transmissions. In some examples, the communication and processing circuitry 2144 may further be configured to provide an indication to the plurality of wireless communication devices, the indication enabling a network coding feature for each of the one or more resource pools. The communication and processing circuitry 2144 may further be configured to execute communication and processing instructions (software) 2154 stored in the computer-readable medium 2106 to implement one or more of the functions described herein.

The processor 2104 may further include network coding manager circuitry 2146, configured to manage sidelink network coding within network coding groups. The network coding manager circuitry 2146 may correspond, for example, to any of the network coding managers of network entities shown in any one or more of FIGS. 1 and/or 2. The network coding manager circuitry 2146 may be configured to configure the resource allocation 2120 for network coding (e.g., for a specific network coding group or for all network coding groups) and to operate together with the communication and processing circuitry 2144 to provide the resource allocation 2120 to the wireless communication devices in the network coding group.

The network coding manager circuitry 2146 may further be configured to configure the pattern(s) 2122 for network coding (e.g., for all resource pools or per resource pool) and to operate together with the communication and processing circuitry 2144 to provide the pattern(s) 2122 to the wireless communication devices in the network coding group. The network coding manager 2146 may further be configured to enable or disable (e.g., activate or deactivate) a network coding feature for a resource pool (or for all resource pools) and to operate together with the communication and processing circuitry 2144 to provide the indication enabling (or disabling) the network coding feature to the wireless communication devices in the network coding group. The network coding manager circuitry 2146 may further be configured to execute network coding manager instructions (software) 2156 stored in the computer-readable medium 2106 to implement one or more of the functions described herein

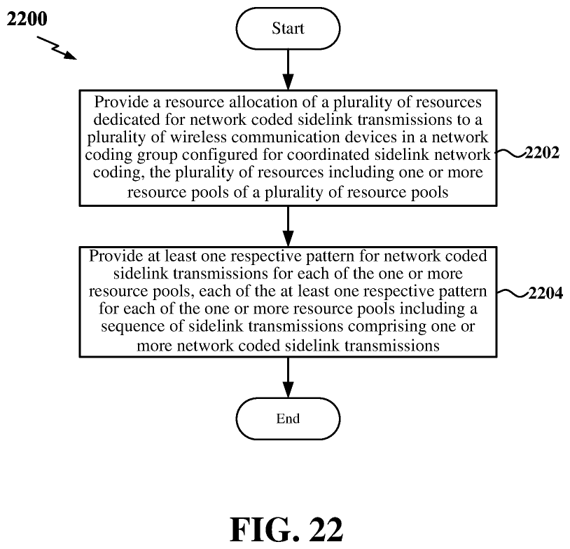

FIG. 22 is a flow chart of an exemplary method for facilitating network coded sidelink transmissions within a network coding group according to some aspects. As described below, some or all illustrated features may be omitted in a particular implementation within the scope of the present disclosure, and some illustrated features may not be required for implementation of all examples. In some examples, the method may be performed by the network entity 2100, as described above and illustrated in FIG. 21, by a processor or processing system, or by any suitable means for carrying out the described functions.

At 2202, the network entity may provide a resource allocation of a plurality of resources dedicated for network coded sidelink transmissions to a plurality of wireless communication devices in a network coding group configured for coordinated sidelink network coding. The plurality of resources can include one or more resource pools of a plurality of resource pools. In some examples, the network entity may further provide an indication to the plurality of wireless communication devices enabling a network coding feature for each of the one or more resource pools. For example, the communication and processing circuitry 2144, together with the network coding manager circuitry 2146 and network interface 2110, shown and described above in connection with FIG. 21 may provide a means to provide the resource allocation.

At 2204, the network entity may provide at least one respective pattern for network coded sidelink transmissions for each of the one or more resource pools. Each of the at least one respective pattern for each of the one or more resource pools includes a sequence of sidelink transmissions including one or more network coded sidelink transmissions. For example, the communication and processing circuitry 2144, together with the network coding manager circuitry 2146 and network interface 2110, shown and described above in connection with FIG. 21 may provide a means to provide the pattern(s).

In one configuration, the network entity 2100 includes means for providing a resource allocation of a plurality of resources dedicated for network coded sidelink transmissions to a plurality of wireless communication devices in a network coding group configured for coordinated sidelink network coding, the plurality of resources comprising one or more resource pools of a plurality of resource pools. In addition, the network entity 2100 includes means for providing at least one respective pattern for network coded sidelink transmissions for each of the one or more resource pools, each of the at least one respective pattern for each of the one or more resource pools comprising a sequence of sidelink transmissions comprising one or more network coded sidelink transmissions. In one aspect, the aforementioned means may be the processor 2104 shown in FIG. 21 configured to perform the functions recited by the aforementioned means. In another aspect, the aforementioned means may be a circuit or any apparatus configured to perform the functions recited by the aforementioned means.

Of course, in the above examples, the circuitry included in the processor 2104 is merely provided as an example, and other means for carrying out the described functions may be included within various aspects of the present disclosure, including but not limited to the instructions stored in the computer-readable storage medium 2106, or any other suitable apparatus or means described in any one of the FIGS. 1, 2, 14, and/or 21 and utilizing, for example, the processes and/or algorithms described herein in relation to FIGS. 14 and 22.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some examples, the network entity 2100 shown and described above in connection with FIG. 21 may be a disaggregated base station. For example, the network entity 2100 shown in FIG. 21 may include the CU and optionally one or more DUs/RUs of the disaggregated base station. Other DUs/RUs associated with the network entity 2100 may be distributed throughout the network. In some examples, the DUs/RUs may correspond to TRPs associated with the network entity. In some examples, the CU and/or DU/RU of the disaggregated base station (e.g., within the network entity 2100) may provide a resource allocation including one or more resource pools dedicated for network coded sidelink transmissions and at least one respective pattern for network coded sidelink transmissions for each of the one or more resource pools to a plurality of wireless communication devices in a network coding group.

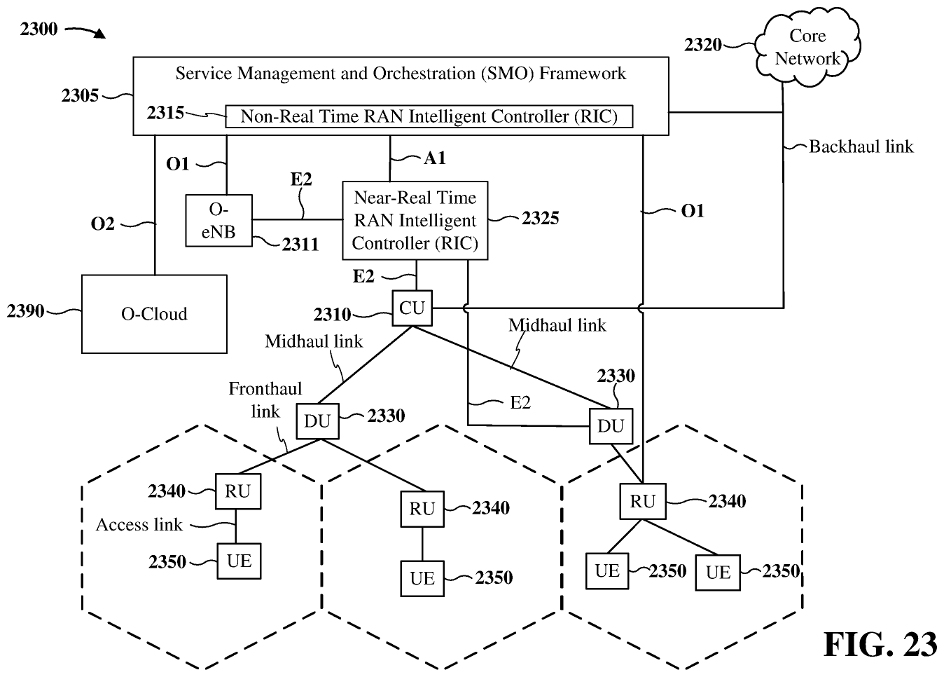

FIG. 23 shows a diagram illustrating an example disaggregated base station 2300 architecture. The disaggregated base station 2300 architecture may include one or more central units (CUs) 2310 that can communicate directly with a core network 2320 via a backhaul link, or indirectly with the core network 2320 through one or more disaggregated base station units (such as a Near-Real Time (Near-RT) RAN Intelligent Controller (RIC) 2325 via an E2 link, or a Non-Real Time (Non-RT) RIC 2315 associated with a Service Management and Orchestration (SMO) Framework 2305, or both). A CU 2310 may communicate with one or more distributed units (DUs) 2330 via respective midhaul links, such as an F1 interface. The DUs 2330 may communicate with one or more radio units (RUs) 2340 via respective fronthaul links. The RUs 2340 may communicate with respective UEs 2350 via one or more radio frequency (RF) access links. In some implementations, the UE 2350 may be simultaneously served by multiple RUs 2340.

Each of the units, i.e., the CUs 2310, the DUs 2330, the RUs 2340, as well as the Near-RT RICs 2325, the Non-RT RICs 2315 and the SMO Framework 2305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 2310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 2310. The CU 2310 may be configured to handle user plane functionality (i.e., Central Unit-User Plane (CU-UP)), control plane functionality (i.e., Central Unit-Control Plane (CU-CP)), or a combination thereof. In some implementations, the CU 2310 can be logically split into one or more CU-UP units and one or more CU-CP units. The CU-UP unit can communicate bidirectionally with the CU-CP unit via an interface, such as the E1 interface when implemented in an O-RAN configuration. The CU 2310 can be implemented to communicate with the DU 2330, as necessary, for network control and signaling.

The DU 2330 may correspond to a logical unit that includes one or more base station functions to control the operation of one or more RUs 2340. In some aspects, the DU 2330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 2330 may further host one or more low PHY layers. Each layer (or module) can be implemented with an interface configured to communicate signals with other layers (and modules) hosted by the DU 2330, or with the control functions hosted by the CU 2310.

Lower-layer functionality can be implemented by one or more RUs 2340. In some deployments, an RU 2340, controlled by a DU 2330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 2340 can be implemented to handle over the air (OTA) communication with one or more UEs 2350. In some implementations, real-time and non-real-time aspects of control and user plane communication with the RU(s) 2340 can be controlled by the corresponding DU 2330. In some scenarios, this configuration can enable the DU(s) 2330 and the CU 2310 to be implemented in a cloud-based RAN architecture, such as a vRAN architecture.

The SMO Framework 2305 may be configured to support RAN deployment and provisioning of non-virtualized and virtualized network elements. For non-virtualized network elements, the SMO Framework 2305 may be configured to support the deployment of dedicated physical resources for RAN coverage requirements which may be managed via an operations and maintenance interface (such as an O1 interface). For virtualized network elements, the SMO Framework 2305 may be configured to interact with a cloud computing platform (such as an open cloud (O-Cloud) 2390) to perform network element life cycle management (such as to instantiate virtualized network elements) via a cloud computing platform interface (such as an O2 interface). Such virtualized network elements can include, but are not limited to, CUs 2310, DUs 2330, RUs 2340 and Near-RT RICs 2325. In some implementations, the SMO Framework 2305 can communicate with a hardware aspect of a 4G RAN, such as an open eNB (O-eNB) 2311, via an O1 interface. Additionally, in some implementations, the SMO Framework 2305 can communicate directly with one or more RUs 2340 via an O1 interface. The SMO Framework 2305 also may include a Non-RT RIC 2315 configured to support functionality of the SMO Framework 2305.

The Non-RT RIC 2315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 2325. The Non-RT RIC 2315 may be coupled to or communicate with (such as via an A1 interface) the Near-RT RIC 2325. The Near-RT RIC 2325 may be configured to include a logical function that enables near-real-time control and optimization of RAN elements and resources via data collection and actions over an interface (such as via an E2 interface) connecting one or more CUs 2310, one or more DUs 2330, or both, as well as an O-eNB, with the Near-RT RIC 2325.

In some implementations, to generate AI/ML models to be deployed in the Near-RT RIC 2325, the Non-RT RIC 2315 may receive parameters or external enrichment information from external servers. Such information may be utilized by the Near-RT RIC 2325 and may be received at the SMO Framework 2305 or the Non-RT RIC 2315 from non-network data sources or from network functions. In some examples, the Non-RT RIC 2315 or the Near-RT RIC 2325 may be configured to tune RAN behavior or performance. For example, the Non-RT RIC 2315 may monitor long-term trends and patterns for performance and employ AI/ML models to perform corrective actions through the SMO Framework 2305 (such as reconfiguration via O1) or via creation of RAN management policies (such as A1 policies).

The following provides an overview of examples of the present disclosure.

Example 1: A method for wireless communication at a first wireless communication device, the method comprising: exchanging one or more sidelink messages with a second wireless communication device to form a network coding group comprising at least the first wireless communication device and the second wireless communication device based on a respective capability of each of the first wireless communication device and the second wireless communication device to support sidelink network coding; and transmitting a network coded sidelink transmission comprising transport blocks associated with at least a first sidelink transmission and a second sidelink transmission to at least the second wireless communication device, the second wireless communication device being an intended recipient of at least one of the first sidelink transmission or the second sidelink transmission.

Example 2: The method of example 1, wherein the second wireless communication device is the intended recipient of the first sidelink transmission and the first sidelink transmission is initiated by the first wireless communication device or another wireless communication device, and further comprising: receiving the second sidelink transmission from a third wireless communication device, the second sidelink transmission being destined for at least a fourth wireless communication device, the network coding group further comprising at least the third wireless communication device and the fourth wireless communication device.

Example 3: The method of example 2, wherein the receiving the second sidelink transmission from the third wireless communication device further comprises: listening to a sidelink channel for the second sidelink transmission initiated by the third wireless communication device and destined for at least the fourth wireless communication device.

Example 4: The method of any of examples 1 through 3, wherein the transmitting the network coded sidelink transmission further comprises: receiving respective feedback for each of the first sidelink transmission and the second sidelink transmission; and transmitting the network coded sidelink transmission in response to the respective feedback.

Example 5: The method of any of examples 1 through 4, wherein the respective capability of each of the first wireless communication device and the second wireless communication device is a dynamic capability based on an energy status thereof.

Example 6: The method of any of examples 1 through 5, wherein the transmitting the network coded sidelink transmission further comprises: transmitting the network coded sidelink transmission based on a probability of transmitting the network coded sidelink transmission instead of respective individual retransmissions of the first sidelink transmission and the second sidelink transmission, wherein the probability is based on at least one of a quality of a sidelink channel, a respective priority of at least one of the first sidelink transmission or the second sidelink transmission, a respective quality of service (QoS) of at least one of the first sidelink transmission or the second sidelink transmission, or a respective remaining packet delay budget of each of the first sidelink transmission and the second sidelink transmission.

Example 7: The method of any of examples 1 through 5, wherein the first sidelink transmission is initiated by the first wireless communication device, and further comprising: deciding whether to send a retransmission of a transport block of the first sidelink transmission or the network coded transmission based on at least one of a quality of a sidelink channel, a priority of the first sidelink transmission, a quality of service (QoS) of the first sidelink transmission, a remaining packet delay budget of the first sidelink transmission, or a fixed number of retransmissions.

Example 8: The method of example 7, wherein the network coded sidelink transmission comprises sidelink control information including a sidelink transmission type field indicating a network coded sidelink transmission type.

Example 9: The method of any of examples 1 through 8, wherein the transmitting the network coded sidelink transmission further comprises: receiving a resource allocation of a plurality of resources dedicated for network coded sidelink transmissions from a network entity; and transmitting the network coded sidelink transmission over a resource of the plurality of resources.

Example 10: The method of example 9, wherein the plurality of resources comprises one or more resource pools of a plurality of resource pools, and further comprising: receiving an indication from the network entity, the indication enabling a network coding feature for each of the one or more resource pools.

Example 11: The method of example 10, wherein the transmitting the network coded sidelink transmission further comprises: transmitting the network coded sidelink transmission as part of a pattern for network coded sidelink transmissions for a resource pool of the one or more resource pools comprising the resource, the pattern comprising a sequence of sidelink transmissions comprising the network coded sidelink transmission.

Example 12: The method of example 11, further comprising: selecting the pattern from a plurality of patterns configured for the resource pool.

Example 13: The method of any of examples 1 through 8, wherein the transmitting the network coded sidelink transmission further comprises: selecting a first resource for the network coded sidelink transmission, wherein the first resource is an earlier resource of at least two resources selected for the network coded sidelink transmission by members of the network coding group or one of the at least two resources that are each used for a respective network coded sidelink transmission.

Example 14: A method for wireless communication at a second wireless communication device, the method comprising: exchanging one or more sidelink messages with a first wireless communication device to form a network coding group comprising at least the first wireless communication device and the second wireless communication device based on a respective capability of each of the first wireless communication device and the second wireless communication device to support sidelink network coding; and receiving a network coded sidelink transmission comprising at least a first sidelink transmission and a second sidelink transmission from the first wireless communication device, the second wireless communication device being an intended recipient of at least one of the first sidelink transmission or the second sidelink transmission.

Example 15: The method of example 14, wherein the respective capability of each of the first wireless communication device and the second wireless communication device is a dynamic capability based on an energy status thereof.

Example 16: The method of example 14 or 15, wherein the receiving the network coded sidelink transmission further comprises: receiving a resource allocation of a plurality of resources dedicated for network coded sidelink transmissions from a network entity; and receiving the network coded sidelink transmission over a resource of the plurality of resources.

Example 17: The method of example 16, wherein the receiving the network coded sidelink transmission further comprises: receiving the network coded sidelink transmission as part of a pattern for network coded sidelink transmissions for a resource pool comprising the resource, the pattern comprising a sequence of sidelink transmissions comprising the network coded sidelink transmission.

Example 18: The method of any of example 14 or 15, wherein the receiving the network coded sidelink transmission further comprises: receiving the network coded sidelink transmission on a first resource, wherein the first resource is an earlier resource of at least two resources selected for the network coded sidelink transmission by members of the network coding group or one of the at least two resources that are each used for a respective network coded sidelink transmission.

Example 19: A wireless communication device configured for wireless communication comprising a memory and a processor coupled to the memory, the processor being configured to perform a method of any of examples 1 through 13 or 14 through 18.

Example 20: A wireless communication device comprising means for performing a method of any of examples 1 through 13 or 14 through 18.

Example 21: A non-transitory computer-readable medium having stored therein instructions executable by one or more processors of a wireless communication device to perform a method of any of examples 1 through 13 or 14 through 18.

Example 22: A method for wireless communication at a network entity, the method comprising: providing a resource allocation of a plurality of resources dedicated for network coded sidelink transmissions to a plurality of wireless communication devices in a network coding group configured for coordinated sidelink network coding, the plurality of resources comprising one or more resource pools of a plurality of resource pools; and providing at least one respective pattern for network coded sidelink transmissions for each of the one or more resource pools, each of the at least one respective pattern for each of the one or more resource pools comprising a sequence of sidelink transmissions comprising one or more network coded sidelink transmissions.

Example 23: The method of example 22, further comprising: providing an indication to the plurality of wireless communication device, the indication enabling a network coding feature for each of the one or more resource pools.

Example 24: A network entity comprising a memory and a processor coupled to the memory, the processor being configured to perform a method of any of examples 22 or 23.

Example 25: A network entity comprising means for performing a method of any of examples 22 or 23.

Example 26: A non-transitory computer-readable medium having stored therein instructions executable by one or more processors of a network entity to perform a method of any of examples 22 or 23.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-23 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 7-12, 14, 18, 21, and/or 23 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first wireless communication device configured for wireless communication, comprising:
a memory; and
a processor coupled to the memory, the processor configured to:
exchange one or more sidelink messages with a second wireless communication device to form a network coding group comprising at least the first wireless communication device and the second wireless communication device based on a respective capability of each of the first wireless communication device and the second wireless communication device to support sidelink network coding; and
transmit a network coded sidelink transmission comprising transport blocks associated with at least a first sidelink transmission and a second sidelink transmission to at least the second wireless communication device, the second wireless communication device being an intended recipient of at least one of the first sidelink transmission or the second sidelink transmission.

2. The first wireless communication device of claim 1, wherein the second wireless communication device is the intended recipient of the first sidelink transmission and the first sidelink transmission is initiated by the first wireless communication device or another wireless communication device, and wherein the processor is further configured to:
receive the second sidelink transmission from a third wireless communication device, the second sidelink transmission being destined for at least a fourth wireless communication device, the network coding group further comprising at least the third wireless communication device and the fourth wireless communication device.

3. The first wireless communication device of claim 2, wherein the processor is further configured to:
listen to a sidelink channel for the second sidelink transmission initiated by the third wireless communication device and destined for at least the fourth wireless communication device.

4. The first wireless communication device of claim 1, wherein the processor is further configured to:
receive respective feedback for each of the first sidelink transmission and the second sidelink transmission; and
transmit the network coded sidelink transmission in response to the respective feedback.

5. The first wireless communication device of claim 1, wherein the respective capability of each of the first wireless communication device and the second wireless communication device is a dynamic capability based on an energy status thereof.

6. The first wireless communication device of claim 1, wherein the processor is further configured to:
transmit the network coded sidelink transmission based on a probability of transmitting the network coded sidelink transmission instead of respective individual retransmissions of the first sidelink transmission and the second sidelink transmission, wherein the probability is based on at least one of a quality of a sidelink channel, a respective priority of at least one of the first sidelink transmission or the second sidelink transmission, a respective quality of service (QoS) of at least one of the first sidelink transmission or the second sidelink transmission, or a respective remaining packet delay budget of each of the first sidelink transmission and the second sidelink transmission.

7. The first wireless communication device of claim 1, wherein the first sidelink transmission is initiated by the first wireless communication device and wherein the processor is further configured to:
decide whether to send a retransmission of a transport block of the first sidelink transmission or the network coded sidelink transmission based on at least one of a quality of a sidelink channel, a priority of the first sidelink transmission, a quality of service (QoS) of the first sidelink transmission, a remaining packet delay budget of the first sidelink transmission, or a fixed number of retransmissions.

8. The first wireless communication device of claim 7, wherein the network coded sidelink transmission comprises sidelink control information including a sidelink transmission type field indicating a network coded sidelink transmission type.

9. The first wireless communication device of claim 1, wherein the processor is further configured to:
receive a resource allocation of a plurality of resources dedicated for network coded sidelink transmissions from a network entity; and
transmit the network coded sidelink transmission over a resource of the plurality of resources.

10. The first wireless communication device of claim 9, wherein the plurality of resources comprises one or more resource pools of a plurality of resource pools and wherein the processor is further configured to:
receive an indication from the network entity, the indication enabling a network coding feature for each of the one or more resource pools.

11. The first wireless communication device of claim 10, wherein the processor is further configured to:
transmit the network coded sidelink transmission as part of a pattern for network coded sidelink transmissions for a resource pool of the one or more resource pools comprising the resource, the pattern comprising a sequence of sidelink transmissions comprising the network coded sidelink transmission.

12. The first wireless communication device of claim 11, wherein the processor is further configured to:
select the pattern from a plurality of patterns configured for the resource pool.

13. The first wireless communication device of claim 1, wherein the processor is further configured to:
select a first resource for the network coded sidelink transmission, wherein the first resource is an earlier resource of at least two resources selected for respective network coded sidelink transmissions by members of the network coding group or one of the at least two resources that are each used for a respective network coded sidelink transmission.

14. A second wireless communication device configured for wireless communication, comprising:
a memory; and
a processor coupled to the memory, the processor configured to:
exchange one or more sidelink messages with a first wireless communication device to form a network coding group comprising at least the first wireless communication device and the second wireless communication device based on a respective capability of each of the first wireless communication device and the second wireless communication device to support sidelink network coding; and
receive a network coded sidelink transmission comprising at least a first sidelink transmission and a second sidelink transmission from the first wireless communication device, the second wireless communication device being an intended recipient of at least one of the first sidelink transmission or the second sidelink transmission.

15. The second wireless communication device of claim 14, wherein the respective capability of each of the first wireless communication device and the second wireless communication device is a dynamic capability based on an energy status thereof.

16. The second wireless communication device of claim 14, wherein the processor is further configured to:
receive a resource allocation of a plurality of resources dedicated for network coded sidelink transmissions from a network entity; and
receive the network coded sidelink transmission over a resource of the plurality of resources.

17. The second wireless communication device of claim 16, wherein the processor is further configured to:
receive the network coded sidelink transmission as part of a pattern for network coded sidelink transmissions for a resource pool comprising the resource, the pattern comprising a sequence of sidelink transmissions comprising the network coded sidelink transmission.

18. The second wireless communication device of claim 14, wherein the processor is further configured to:
receiving the network coded sidelink transmission on a first resource, wherein the first resource is an earlier resource of at least two resources selected for respective network coded sidelink transmissions by members of the network coding group or one of the at least two resources that are each used for a respective network coded sidelink transmission.

19. A network entity, comprising:
a memory; and
a processor coupled to the memory, the processor configured to:
provide a resource allocation of a plurality of resources dedicated for network coded sidelink transmissions to a plurality of wireless communication devices in a network coding group configured for coordinated sidelink network coding, the plurality of resources comprising one or more resource pools of a plurality of resource pools; and
provide at least one respective pattern for network coded sidelink transmissions for each of the one or more resource pools, each of the at least one respective pattern for each of the one or more resource pools comprising a sequence of sidelink transmissions comprising one or more network coded sidelink transmissions.

20. The network entity of claim 19, wherein the processor is further configured to:
provide an indication to the plurality of wireless communication devices, the indication enabling a network coding feature for each of the one or more resource pools.
